(19) United States
(12) Patent Application Publication
(10) Pub. No.: US 2026/0093469 A1
(43) Pub. Date: Apr. 2, 2026

(54) Light Weight Mainframe Orchestration Engine

(71) Applicant: Bank of America Corporation, Charlotte, NC (US)

(72) Inventors: Panduranga Dongle, Hyderabad Telangana (IN); Ganesh Perumal, Chennai (IN); John Watkins, Old Cousldon (GB); Georgios Apostolakis, Bromley (GB); Keerthana Srinivasan, Orpington (GB)

(21) Appl. No.: 18/904,169

(22) Filed: Oct. 2, 2024

(51) Int. Cl. G06F 8/60; G06F 8/41; G06F 8/71; G06F 11/26; G06F 11/36; H04L 9/06

(52) U.S. Cl. CPC G06F 8/60; G06F 8/433; G06F 8/71; G06F 11/26; G06F 11/3688; H04L 9/0643

(57) ABSTRACT

Systems and methods provide novel inventions for integrating mainframe applications into modern Continuous Integration/Continuous Deployment (CI/CD) pipelines using BEARDS (Build Engineering And Rapid Development System), a Java-based interface. BEARDS facilitates the automation of build, test, and deployment processes for mainframe applications by managing source code, dependencies, and artifacts in a technology-agnostic manner. The system dynamically generates Job Control Language (JCL) jobs to compile mainframe code, integrates with CI/CD tools like Jenkins, JFrog Artifactory, and Ansible, and ensures secure, compliant deployments through detailed instructions and verification processes. BEARDS also supports large artifact management, incremental builds, and seamless integration with cloud platforms, providing scalability and flexibility for complex applications. By bridging the gap between legacy mainframe systems and modern DevOps practices, the invention enables organizations to automate and streamline their mainframe development processes, reducing costs, improving efficiency, and maintaining the reliability and security of critical applications.

### TECHNICAL FIELD

The inventions disclosed herein pertain to the field of data processing, particularly involving database and file management or data structures. Specifically, the inventions address and compliment orchestration by compilation and deployment of mainframe-based applications within a Continuous Integration/Continuous Deployment (CI/CD) pipeline, focusing on the efficient management and utilization of metadata, dependencies, and source code repositories. By integrating mainframe environments with modern DevOps tools, these systems enable the streamlined processing, storage, retrieval, and manipulation of data across various platforms, ensuring that data integrity and accessibility are maintained throughout the deployment process. This invention is particularly relevant to the management of complex data structures and the optimization of database interactions within large-scale, distributed computing environments.

### DESCRIPTION OF THE RELATED ART

The problem addressed by this invention arises from the inherent complexities and inefficiencies in managing and deploying mainframe applications within modern software development environments. Mainframes, often running critical legacy applications, are notoriously difficult to integrate with contemporary DevOps practices, particularly in the context of Continuous Integration and Continuous Deployment (CI/CD) pipelines. The challenge is exacerbated by the unique characteristics of mainframe systems, which typically involve highly specialized hardware and software configurations that are not easily compatible with the flexible, iterative processes that define modern DevOps practices.

One of the primary difficulties lies in the rigidity of mainframe environments. Mainframe systems are designed to be stable and reliable, often running applications that were developed decades ago. These systems operate with a high degree of specificity, relying on particular languages, tools, and processes that are not readily adaptable to the rapidly changing needs of modern development teams. This rigidity creates significant barriers when attempting to integrate mainframe applications into CI/CD pipelines, which are built on principles of agility, automation, and continuous feedback.

Additionally, the tools and processes traditionally used in mainframe development are often outdated compared to those used in modern development environments. While modern software development relies heavily on open-source tools, cloud-based services, and automated workflows, mainframe development typically depends on proprietary software, manual processes, and a highly specialized skill set. This disconnect means that development teams working with mainframes often find themselves siloed, unable to leverage the efficiencies and collaborative benefits that modern DevOps practices provide.

Another significant problem is the lack of seamless communication between mainframe systems and the tools used in modern CI/CD pipelines. Mainframe systems typically operate in isolation from the rest of the IT infrastructure, using proprietary protocols and file formats that are not easily interpreted by modern tools. This lack of interoperability complicates the process of integrating mainframe applications into broader development workflows, leading to delays, errors, and increased costs.

Furthermore, the dependency management in mainframe applications presents a unique challenge. Mainframe applications often consist of thousands of interdependent files, each with its own set of dependencies. Managing these dependencies manually is a time-consuming and error-prone process, particularly in the context of CI/CD pipelines, where changes need to be rapidly tested and deployed. The lack of automated tools for dependency management in mainframe environments further complicates the integration of these applications into modern development workflows.

In addition, the build processes for mainframe applications are often incompatible with the automated build systems used in modern development environments. Mainframe builds typically require specific configurations and steps that are not supported by standard build automation tools. This incompatibility forces development teams to either manually manage the build process or create custom solutions, both of which are time-consuming and prone to errors.

The deployment of mainframe applications also presents significant challenges. Unlike modern applications, which can be easily deployed across multiple environments using automated tools, mainframe applications often require manual intervention during deployment. This manual process not only increases the risk of errors but also slows down the overall deployment process, making it difficult to achieve the rapid release cycles that are a hallmark of modern DevOps practices.

Moreover, the testing of mainframe applications is a complex and resource-intensive process. Mainframes often run mission-critical applications that require thorough testing before deployment. However, the lack of automated testing tools for mainframe environments makes it difficult to integrate these applications into CI/CD pipelines, where automated testing is a key component. This lack of automation leads to longer testing cycles and increases the risk of defects making it into production.

The problem is further compounded by the high costs associated with mainframe development. The specialized tools, proprietary software, and manual processes required for mainframe development are expensive to maintain and operate. These costs are exacerbated by the need for specialized personnel who are trained in mainframe technologies, making it difficult for organizations to scale their development efforts or respond quickly to changing market demands.

Additionally, there is a significant skills gap in the workforce when it comes to mainframe development. As more developers focus on modern programming languages and tools, fewer individuals are trained in the specialized skills needed to work with mainframes. This skills gap creates a bottleneck in the development process, as organizations struggle to find qualified personnel to maintain and develop their mainframe applications.

Another issue is the lack of flexibility in mainframe environments. Unlike modern development environments, which are designed to be flexible and adaptable, mainframe systems are often rigid and difficult to modify. This lack of flexibility makes it challenging to implement new features or respond to changes in the market, as any modifications to the system require significant time and resources.

Furthermore, the security requirements of mainframe applications add another layer of complexity to the development process. Mainframes often handle sensitive data, which requires strict security controls and compliance with regulatory standards. Integrating these security requirements into a CI/CD pipeline, which is designed for rapid iteration and deployment, is a significant challenge. The need to ensure security and compliance while maintaining the speed and efficiency of the development process creates a tension that is difficult to resolve.

The integration of mainframe applications into modern IT infrastructure is also problematic. Mainframes often operate in isolation from the rest of the IT environment, using outdated protocols and file formats. This isolation makes it difficult to integrate mainframe applications with other systems, leading to inefficiencies and increased operational costs. The lack of integration also makes it challenging to leverage modern technologies, such as cloud computing, which are designed to work with more flexible and interconnected systems.

Finally, the traditional waterfall development approach often used in mainframe environments is at odds with the agile methodologies that dominate modern software development. Waterfall development, with its linear and sequential phases, does not lend itself well to the iterative and incremental nature of agile development. This misalignment creates friction between teams working on mainframe applications and those working on modern applications, further complicating efforts to integrate these systems.

The long felt and unmet need for this invention lies in the demand for a solution that bridges the gap between legacy mainframe systems and modern DevOps practices. Organizations have long struggled with the inefficiencies and complexities of managing mainframe applications within a CI/CD framework, resulting in delayed deployments, increased costs, and a reliance on outdated tools and processes. The need for a solution that enables seamless integration of mainframe environments into modern development workflows, while maintaining the stability, security, and performance of these critical systems, has remained unmet despite decades of technological advancements. This invention addresses this gap, offering a solution that finally allows organizations to fully leverage their mainframe investments while embracing the efficiencies of modern DevOps practices.

### SUMMARY OF THE INVENTION

The systems and methods of the invention(s) disclosed herein represents a significant advancement in the integration of mainframe applications into modern Continuous Integration/Continuous Deployment (CI/CD) pipelines, an area that has long been fraught with challenges due to the unique nature of mainframe environments. At the center of this invention is BEARDS (Build Engineering And Rapid Development System), a sophisticated Java-based interface that serves as a bridge between the rigid, specialized world of mainframe computing and the flexible, automated processes that define contemporary DevOps practices. BEARDS is designed to facilitate the seamless compilation and packaging of mainframe applications within a CI/CD pipeline, making it possible to automate processes that have traditionally required significant manual intervention and specialized expertise.

BEARDS operates by interfacing directly with the source control systems used in modern software development, such as Git or Bitbucket. These systems are where developers commit and manage their source code, and BEARDS is responsible for tracking changes in this codebase. Whenever a developer makes changes to the mainframe application's source code, BEARDS is invoked by Jenkins, detects these changes, and initiates the necessary steps to build and package the updated application. This process begins with the retrieval of the relevant source code files, including all dependencies, from the repository. BEARDS is designed to handle the complexity of mainframe applications, which often involve thousands of interdependent files. It maintains a detailed database that maps these dependencies, ensuring that all necessary files are included in the build process.

The dependency management capabilities of BEARDS are a critical aspect of its functionality. In the context of mainframe applications, where interdependencies are complex and pervasive, the ability to automatically identify and retrieve dependent files is essential. BEARDS accomplishes this by querying its dedicated dependency database, which is continuously updated as changes are made to the source code. This ensures that the build process is always based on the most accurate and current information, reducing the risk of build failures due to missing or outdated dependencies. This automated approach to dependency management represents a significant improvement over traditional methods, which often rely on manual tracking and are prone to errors.

Once the necessary files have been identified and retrieved, BEARDS proceeds to the build phase. Mainframe applications require specific build processes that are not typically supported by the standard automation tools used in modern CI/CD pipelines. BEARDS addresses this by taking over the build responsibilities, interfacing with the mainframe environment to compile the source code into executable artifacts. This process involves generating Job Control Language (JCL) jobs, which provide the mainframe with the instructions needed to compile the application. BEARDS generates these scripts dynamically, based on the specific requirements of the application and the changes that have been made to the source code.

After the build process is complete, BEARDS creates a package with the compiled artifacts into a predetermined directory, from where Jenkins picks it up and uploads it to a centralized storage system, typically JFrog Artifactory. This system acts as a repository for the build artifacts, storing them in a format that can be easily accessed and used by other tools in the CI/CD pipeline. The transfer process between the mainframe and the Jenkins'directory is designed to ensure the integrity of the artifacts, with BEARDS generating hash values that are compared before and after the transfer to detect any potential corruption. This step is crucial for maintaining the reliability of the deployment process, as corrupted artifacts could lead to failures or downtime in production environments.

The deployment phase of the CI/CD pipeline is another point where special customization is required. Mainframe applications, due to their complexity and the specific nature of their runtime environments, present unique challenges during deployment. Modern automation tools like XLRelease and Ansible are assigned to manage the deployment of mainframe artifacts. For reference, XLRelease is a release orchestration tool designed to automate, manage, and monitor the deployment of software releases. It helps teams coordinate their release pipelines, manage dependencies, and streamline the entire release process by integrating with other tools and providing visibility into the stages of development. XLRelease enables organizations to automate and standardize their release processes, ensuring efficient delivery of software across environments. And Ansible is an open-source automation tool used for configuration management, application deployment, and task automation. It utilizes a simple, agentless architecture to automate repetitive tasks, provision infrastructure, and manage systems. Ansible operates using YAML-based playbooks that describe the desired state of systems and allows users to automate processes like deploying software, managing servers, and orchestrating complex workflows in IT environments.

The foregoing integration is facilitated by the YML files generated during the CI process by BEARDS, which contain detailed instructions for deploying the artifacts within the mainframe environment. These instructions specify the exact datasets and configurations required for each artifact, ensuring that the deployment process is carried out accurately and efficiently.

One of the standout features of BEARDS is its ability to operate in a technology-agnostic manner. While mainframe systems are traditionally tied to specific hardware and software configurations, BEARDS abstracts these details and presents them in a format that is compatible with any modern CI/CD tool. This level of abstraction allows organizations to integrate their mainframe applications into existing CI/CD pipelines without the need for extensive modifications or custom solutions. This not only reduces the cost and complexity of integrating mainframe systems but also allows organizations to leverage their existing DevOps investments to manage their mainframe environments more effectively.

In addition to its core functionalities, BEARDS includes several advanced features that enhance its usability and scalability. For example, BEARDS is capable of handling large artifacts that may be generated during the build process. In cases where an application produces particularly large artifacts, BEARDS offers the option to maintain these artifacts within the mainframe environment, rather than transferring them to external storage. This reduces the overhead associated with transferring large files and ensures that the build and deployment process remain efficient, even for resource-intensive applications. This feature is particularly valuable in environments where network bandwidth is limited or where the time required to transfer large files could delay the deployment process.

Security is another area where BEARDS excels. Mainframe applications often handle sensitive data and are subject to strict regulatory requirements. BEARDS is designed with these considerations in mind, providing robust security features that ensure compliance with industry standards. The system includes detailed logging and audit trails that document every step of the build and deployment process. These logs can be reviewed to verify that all security protocols were followed and that the deployment was carried out in accordance with the organization's security policies. Additionally, BEARDS integrates with tools like Ansible and XL Release to implement approval processes and access controls, ensuring that only authorized personnel can initiate deployments to critical environments.

The flexibility of BEARDS is one of its most significant strengths. The system is highly configurable, allowing it to be tailored to the specific needs of different organizations and applications. Users can define custom build and deployment steps, manage multiple environments, and integrate with a wide range of third-party tools and services. This flexibility makes BEARDS a versatile solution that can be adapted to meet the unique requirements of any organization, regardless of the complexity of their mainframe environment or the specific tools they use in their CI/CD pipeline.

Scalability is another key feature of BEARDS. As organizations continue to expand their mainframe applications and integrate them with modern systems, the need for scalable CI/CD processes becomes increasingly important. BEARDS is designed to scale with the needs of the organization, handling larger and more complex applications without compromising performance. This scalability is essential for organizations that are looking to modernize their mainframe environments and integrate them into broader IT strategies.

BEARDS also supports the adoption of agile development practices within mainframe environments. While mainframe development has traditionally followed a waterfall model, BEARDS enables organizations to adopt more iterative and incremental approaches. The system supports incremental builds, where only the changed files are recompiled, reducing the time and resources required for each build. This capability aligns with the principles of agile development, allowing organizations to respond more quickly to changes and deliver updates to their mainframe applications with greater speed and efficiency.

The integration of BEARDS with cloud-based services is another significant feature. As more organizations move to hybrid cloud environments, the ability to integrate mainframe applications with cloud platforms becomes increasingly important. BEARDS provides the necessary interfaces and connectors to enable this integration, allowing organizations to leverage the scalability, flexibility, and cost-efficiency of cloud computing while maintaining their investment in mainframe systems. This capability is particularly valuable for organizations that are looking to modernize their IT infrastructure and ensure that their mainframe applications can operate seamlessly within a cloud-based environment.

Collaboration is also enhanced by BEARDS. The system provides a common platform for managing both mainframe and modern applications, facilitating communication and coordination between development, operations, and security teams. This collaboration is critical for ensuring that mainframe applications are developed, tested, and deployed in a manner that aligns with the organization's overall IT strategy. BEARDS's detailed logging and reporting capabilities also provide valuable insights into the performance and status of the CI/CD pipeline, allowing teams to identify and address issues proactively, thereby improving the overall efficiency and reliability of the software development process.

The invention is also designed with a focus on user-friendliness. BEARDS provides an intuitive interface that allows developers and operations teams to manage the build and deployment process without requiring deep expertise in mainframe technologies. This ease of use is further enhanced by the system's integration with popular CI/CD tools, allowing users to continue working within their preferred environments. This reduces the learning curve associated with adopting BEARDS and increases its appeal to organizations that are looking to streamline their mainframe development processes without disrupting their existing workflows.

Finally, BEARDS offers a substantial return on investment for organizations that rely on mainframe systems. By automating and streamlining the build and deployment process, BEARDS reduces the time and cost associated with maintaining and updating mainframe applications. This efficiency not only improves the organization's ability to deliver new features and updates to market but also reduces the risk of errors and downtime, ensuring that critical mainframe applications remain reliable and secure. The invention represents a significant leap forward in the field of mainframe development and DevOps, providing a comprehensive solution to the challenges associated with integrating legacy systems into modern software development practices.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for automating the integration and deployment of mainframe applications into a Continuous Integration/Continuous Deployment (CI/CD) pipeline using a system comprising BEARDS (Build Engineering And Rapid Development System) is used. The method includes several steps, beginning with BEARDS being triggered by Jenkins, once a change has been detected in the monitored source control system of a mainframe application. This monitoring process identifies modifications to repository structure, branch updates, and individual code commits. Once BEARDS is triggered, it retrieves the modified source code, including any dependencies, from the source control system, ensuring that the retrieval process accounts for branch-specific changes and integrates any ongoing merge operations.

BEARDS then queries a dependency database to automatically identify and resolve additional dependencies required for the build process. Following this, BEARDS generates Job Control Language (JCL) jobs tailored to the specific requirements of the mainframe environment, dynamically adjusting compiler options, memory allocation, and execution parameters based on current configuration and the specific needs of the build. The build process is initiated by BEARDS within the mainframe environment using the generated JCL jobs to compile the source code into executable artifacts, including preprocessing steps for files not natively supported by the mainframe to ensure compatibility.

After compiling the artifacts, BEARDS downloads them into a predetermined directory accessible by Jenkins, and performs validation using a SHA-256 hash algorithm to generate hash values, thereby ensuring the integrity of the downloaded (from the mainframe) artifacts and verifying that they have not been altered. It also updates the database with any newly discovered or modified dependencies. The validated compiled artifacts are then transferred by Jenkins to an artifact repository for secure storage and version control, with a new SHA-256 hash generated to ensure the integrity of the artifacts during and after the transfer. BEARDS further generates YML files containing detailed deployment instructions specific to the mainframe environment, including configurations, dataset assignments, pre-deployment checks, and environment-specific parameters necessary for successful deployment. Those YML files are also transferred by Jenkins to the same artifact repository as the compiled artifact.

The deployment process is carried out by XLRelease and Ansible, utilizing the generated YML files to deploy the validated and versioned compiled artifacts from the artifact repository to the mainframe environment, ensuring that all configurations and dataset assignments are correctly applied. Ansible validates the deployment process through automated functional and non-functional tests, including SHA-256 hash-based validation to confirm that the deployed artifacts match the versioned artifacts in the repository. Ansible then manages the post-deployment process by generating automated notifications to stakeholders, updating deployment status logs, and creating detailed reports that document each step of the deployment process and its outcomes. To secure the deployment process, XLRelease implements role-based access controls to restrict who can initiate, monitor, or modify deployments, and logs all actions taken during the deployment in an immutable audit trail for compliance and security verification. Finally, XLRelease and Ansible scales the deployment process across multiple environments, including development (DEV), quality assurance (QA), and production (PROD), handling parallel build and deployment tasks, ensuring consistency and integrity of artifacts across all environments, and managing large-scale deployments by retaining significant artifacts within the mainframe environment to minimize transfer overhead and enhance deployment efficiency.

In some arrangements, the retrieving step further includes fetching related commit history, branch metadata, and version information from the source control system. This ensures that all relevant data is available for the build process, providing a comprehensive context for the changes being integrated.

In some arrangements, the generating of the JCL jobs includes selecting optimal compiler settings and execution parameters based on real-time analysis of the mainframe's resource availability and workload. This optimization ensures that the build process is efficient and tailored to the current conditions of the mainframe environment.

In some arrangements, the initiating of the build process includes executing a preprocessing phase that converts non-native file formats into mainframe-compatible formats. This preprocessing ensures that all source code is fully compatible with the mainframe's build environment, reducing the likelihood of errors during the build process.

In some arrangements, the performing of validation using the SHA-256 hash algorithm includes generating a hash value for each compiled artifact both before and after the build process. This step ensures that no unauthorized modifications have occurred during the downloading process of the artifact, from the mainframe to the Jenkins' directory, maintaining the integrity of the artifacts.

In some arrangements, the dependency update step automatically resolves conflicts between existing and newly discovered dependencies, ensuring that the build process runs smoothly.

In some arrangements, the transferring of the validated compiled artifacts which is performed by Jenkins, includes generating a new SHA-256 hash after the transfer to ensure the integrity of the artifacts during storage in the artifact repository. This additional validation step provides further assurance that the artifacts remain unchanged after transfer.

In some arrangements, the artifact repository is a version-controlled system, such as JFrog Artifactory, and the storing process includes managing multiple versions of the artifacts. Each version is associated with its respective SHA-256 hash for verification, ensuring that the correct version of the artifact is used in subsequent processes.

In some arrangements, the deploying step further includes using automation tools such as Ansible to perform the tasks described in the YML files. This approach ensures that the deployment is carried out consistently and efficiently across all target environments, maintaining the reliability of the deployment process.

In some arrangements, the managing of the post-deployment process includes automatically generating and distributing detailed deployment reports. These reports include the results of the SHA-256 hash validation, functional tests, and any issues encountered during deployment, providing a complete overview of the deployment process.

In some arrangements, the securing step further includes creating an immutable audit trail that records every action taken during the deployment. Each entry in the audit trail is digitally signed and timestamped to prevent tampering, ensuring that the deployment process is fully transparent and secure.

In some arrangements, the scaling step includes optimizing the deployment process for high-volume environments by parallelizing tasks and using resource allocation strategies. These strategies reduce bottlenecks and ensure consistent deployment performance, even in large-scale operations.

In some arrangements, the scaling step further includes managing large-scale deployments by retaining and caching significant artifacts within the mainframe environment. This approach reduces the need for repeated transfers from external storage systems, enhancing deployment speed and reliability.

In some arrangements, the BEARDS system enables incremental builds by only recompiling and deploying source code files that have changed. This reduces the overall time and resources required for each build and ensures faster turnaround times for application updates, making the deployment process more efficient.

In some arrangements, a method for automating the integration, validation, and deployment of mainframe applications within a Continuous Integration/Continuous Deployment (CI/CD) pipeline using BEARDS (Build Engineering And Rapid Development System) is used. The method involves continuously monitoring a source control system by Jenkins to detect changes in the source code of a mainframe application. This includes tracking modifications to repository structure, branch updates, individual code commits, and merge operations. The monitoring process involves real-time notifications and automated triggers for subsequent build processes. Upon detecting changes, BEARDS is executed by Jenkins and retrieves the modified source code, including associated metadata, version information, and dependencies from the source control system. BEARDS ensures that all relevant branches, commit histories, and ongoing merges are incorporated into the retrieval process to maintain the integrity of the codebase.

BEARDS then dynamically queries a dependency database to identify and resolve additional dependencies required for the build process. Following this, BEARDS generates Job Control Language (JCL) jobs customized to the specific requirements of the mainframe environment. The generation process involves dynamically adjusting compiler options, memory allocations, and execution parameters based on a real-time analysis of the mainframe's resource availability, current system load, and configuration settings.

The build process is initiated by BEARDS within the mainframe environment using the generated JCL jobs to compile the source code into executable artifacts. This build process includes preprocessing steps for files not natively supported by the mainframe to ensure compatibility and integrates additional build steps tailored to optimize performance, resource usage, and error handling. After compiling the artifacts, BEARDS downloads them from the mainframe into a predetermined directory accessible by Jenkins and performs a rigorous validation of the downloaded artifacts using a SHA-256 hash algorithm. Hash values are generated both before and after the downloading process to ensure the integrity of the artifacts and verify that they have not been altered during the transfer. Finally, BEARDS updates the dependency database with any new dependencies detected during retrieval, resolves conflicts, and ensures that all dependencies are correctly configured for the mainframe environment.

Jenkins securely transfers the validated compiled artifacts to an artifact repository that is version-controlled, such as JFrog Artifactory. The transfer process includes generating a new SHA-256 hash verification post-transfer to ensure the integrity of the artifacts during storage, managing multiple versions of the artifacts, and associating each version with its respective hash value for easy retrieval, validation, and deployment. Detailed YML files containing comprehensive deployment instructions specific to the mainframe environment are also generated by BEARDS and transferred into the artifactory by Jenkins. These YML files include configurations, dataset assignments, pre-deployment validation checks, environment-specific parameters, and rollback procedures necessary to ensure a successful and optimized deployment process.

XLRelease and Ansible then execute the deployment of the validated and versioned compiled artifacts from the artifact repository to the mainframe environment. The deployment utilizes the generated YML files to ensure that the deployment is carried out consistently, efficiently, and securely across multiple environments, including development (DEV), quality assurance (QA), and production (PROD). SHA-256 hash-based validation is used to confirm that the deployed artifacts match the versioned artifacts stored in the repository, and deployment status logs are updated with detailed test results and deployment outcomes.

XLRelease and Ansible manage the post-deployment process, which includes automatically generating and distributing detailed deployment reports to stakeholders. These reports include the results of the SHA-256 hash validation, test outcomes, performance metrics, and any issues encountered during deployment. All deployment actions are logged, digitally signed, timestamped, and stored in a tamper-proof environment to ensure compliance with security policies and regulatory requirements.

BEARDS also scales the deployment process across multiple environments by managing resource allocation to reduce bottlenecks, and retaining and caching large artifacts within the mainframe environment to minimize the need for repeated external transfers. This approach enhances deployment speed, reduces latency, and ensures consistent performance, particularly in high-volume, enterprise-level operations. BEARDS enables incremental builds, where only modified or updated source code files are recompiled and redeployed. This reduces the overall time, resource usage, and risk associated with each build while maintaining the integrity and consistency of the deployed application across all target environments. Additionally, BEARDS integrates with cloud-based services to support hybrid cloud environments, allowing for the seamless transfer and deployment of artifacts and configurations between on-premise mainframe systems and cloud-based infrastructure. This integration provides flexibility, scalability, and the ability to leverage cloud resources for testing, deployment, and scaling operations while maintaining the security and integrity of the mainframe applications.

In some arrangements, a system for automating the integration, validation, and deployment of mainframe applications within a Continuous Integration/Continuous Deployment (CI/CD) pipeline is utilized. The system comprises multiple modules, each tailored to specific functions within the CI/CD pipeline. A source control module is configured to continuously monitor a source control system for changes in the source code of a mainframe application. This module detects modifications to repository structure, branch updates, individual code commits, and merge operations, triggering subsequent build processes in response to detected changes. A retrieval module is responsible for retrieving modified source code, including associated metadata, version information, and dependencies from the source control system. This module ensures that all relevant branches, commit histories, and merge operations are incorporated into the retrieval process to maintain codebase integrity.

A dependency management module dynamically queries a dependency database to identify and resolve additional dependencies required for the build process. The module automatically updates the dependency database with any new dependencies after the completion of the build, resolves conflicts, and ensures that all dependencies are correctly configured for the mainframe environment. The system also includes a JCL generation module that generates Job Control Language (JCL) jobs customized to the specific requirements of the mainframe environment. This module dynamically adjusts compiler options, memory allocations, and execution parameters based on a real-time analysis of the mainframe's resource availability, system load, and configuration settings.

The build module initiates the build process within the mainframe environment using the generated JCL jobs to compile the source code into executable artifacts. This module includes preprocessing capabilities for files not natively supported by the mainframe and integrates additional build steps tailored to optimize performance, resource usage, and error handling. A validation module performs rigorous validation of the compiled artifacts using a SHA-256 hash algorithm. The module generates hash values before and after the transfer process to ensure the integrity of the artifacts, and verifies that they have not been altered during the downloading from the mainframe into the Jenkins' directory.

An artifact management module securely transfers the validated compiled artifacts to an artifact repository that is version-controlled, such as JFrog Artifactory. The module generates a new SHA-256 hash post-transfer to ensure the integrity of the artifacts during storage, manages multiple versions of the artifacts, and associates each version with its respective hash value for easy retrieval, validation, and deployment. A YML generation module generates detailed YML files containing comprehensive deployment instructions specific to the mainframe environment. These YML files include configurations, dataset assignments, pre-deployment validation checks, environment-specific parameters, and rollback procedures to ensure a successful and optimized deployment process.

The deployment module executes the deployment of the validated and versioned compiled artifacts from the artifact repository to the mainframe environment. The module utilizes the generated YML files and automation tools such as Ansible to ensure that the deployment is carried out consistently, efficiently, and securely across multiple environments, including development (DEV), quality assurance (QA), and production (PROD). A deployment validation module validates the deployment process through automated functional and non-functional tests, including unit testing, integration testing, performance testing, and security testing. The module also uses SHA-256 hash-based validation to confirm that the deployed artifacts match the versioned artifacts stored in the repository and updates deployment status logs with detailed test results and deployment outcomes.

A post-deployment management module manages the post-deployment process, which includes automatically generating and distributing detailed deployment reports to stakeholders. These reports include the results of the SHA-256 hash validation, test outcomes, performance metrics, and any issues encountered during deployment. The module updates deployment status logs, provides real-time feedback on deployment progress, and archives the reports for future reference and compliance purposes.

A scaling module optimizes the deployment process across multiple environments by managing resource allocation to reduce bottlenecks, and retaining and caching large artifacts within the mainframe environment. This approach minimizes the need for repeated external transfers, enhances deployment speed, reduces latency, and ensures consistent performance, particularly in high-volume, enterprise-level operations. An incremental build module enables incremental builds by recompiling and redeploying only modified or updated source code files. This reduces the overall time, resource usage, and risk associated with each build while maintaining the integrity and consistency of the deployed application across all target environments. The module ensures that subsequent builds integrate seamlessly with previous deployments.

A cloud integration module supports hybrid cloud environments by enabling the seamless transfer and deployment of artifacts and configurations between on-premise mainframe systems and cloud-based infrastructure. This provides flexibility, scalability, and the ability to leverage cloud resources for testing, deployment, and scaling operations while maintaining the security and integrity of the mainframe applications.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts the architecture and operational flow of the Build Engineering And Rapid Development System (BEARDS) within a CI/CD pipeline, highlighting how BEARDS orchestrates the processes of compiling and packaging of mainframe applications. The figure illustrates the interaction between BEARDS and various components, such as source control systems, dependency management, and artifact repositories.

FIG. 2 depicts the Continuous Integration (CI) process managed by BEARDS, focusing on the automation of tasks such as source code retrieval, dependency management, and build initiation. The figure shows how BEARDS interacts with tools like Jenkins and IBM IDz to ensure a seamless and efficient CI process for mainframe applications.

FIG. 3 depicts the Continuous Deployment (CD) process within the CI/CD pipeline, illustrating the steps involved in deploying compiled artifacts to multiple environments, including development, quality assurance, and production. The figure highlights the automation and validation processes that ensure successful and consistent deployment across all environments.

FIG. 4 depicts an Entity-Relationship Diagram (ERD) showing the relationships between various components of the BEARDS system, including source control systems, build processes, and deployment environments. The figure provides a detailed view of how these entities interact to manage the CI/CD pipeline for mainframe applications.

FIG. 5 depicts a Class Diagram that outlines the object-oriented structure of the BEARDS system, detailing the attributes, methods, and relationships of the classes involved in managing the CI/CD pipeline. The figure illustrates how BEARDS is designed to handle the complexities of mainframe application development, testing, and deployment.

FIG. 6 depicts a Sequence Diagram that illustrates the step-by-step flow of operations within the BEARDS system, from source code monitoring to post-deployment The figure shows how BEARDS coordinates, source control systems, and mainframe environments to ensure a smooth CI/CD process.

FIG. 7 depicts a Sequence Diagram that provides a detailed view of the automation processes managed by BEARDS, focusing on the continuous monitoring, retrieval, and deployment of mainframe application code. The figure highlights the interactions between BEARDS and cloud-based services, emphasizing the system's ability to support hybrid cloud environments.

FIG. 8 depicts a detailed Workflow Diagram that outlines automated remediation processes conducted by BEARDS.

### DETAILED DESCRIPTION

The inventions presented offer transformative approaches to integrating mainframe applications into modern Continuous Integration/Continuous Deployment (CI/CD) pipelines. At its core, the invention utilizes a sophisticated system known as BEARDS, or Build Engineering And Rapid Development System, which is designed to bridge the gap between the traditional world of mainframe computing and the rapidly evolving domain of modern DevOps practices. BEARDS serves as a critical interface that automates the processes involved in building, testing, and deploying mainframe applications, thus allowing these legacy systems to be seamlessly incorporated into contemporary CI/CD workflows.

One of the most significant features of this invention is its ability to interface directly with source control systems that are widely used in the software development industry, such as Git and Bitbucket. Jenkins continuously monitors these repositories for changes in the mainframe application's source code. Upon detecting any modifications, it triggers the execution of BEARDS and initiates the appropriate processes to compile, test, and deploy the updated application. This automation ensures that the application is always kept up to date and ready for deployment, reducing the manual effort traditionally associated with mainframe application management and enabling faster, more reliable software releases.

The invention's advanced dependency management capabilities are another key aspect that sets it apart. Mainframe applications often involve a complex web of interdependencies among thousands of files. BEARDS manages these dependencies by maintaining a comprehensive database that tracks the relationships between different components of the application. This database is continuously updated to reflect the latest changes in the source code, ensuring that the build process includes all necessary files. By automating this dependency management process, BEARDS eliminates the risk of errors that can occur when dependencies are tracked manually, thereby improving the reliability of the build process.

In addition to managing dependencies, BEARDS plays a pivotal role in the build process itself. Mainframe applications require specific build procedures that are not typically supported by standard CI/CD tools. BEARDS addresses this challenge by generating Job Control Language (JCL) jobs that are customized to the needs of the mainframe environment. These jobs provide the instructions necessary for the mainframe to compile the application's source code into executable artifacts. Once the build is complete, BEARDS oversees the transfer of these artifacts to a centralized repository, such as JFrog Artifactory, where they are stored and made available for subsequent stages of the CI/CD pipeline.

The deployment of mainframe applications is another area where the invention demonstrates its innovative capabilities. BEARDS integrates with modern automation tools like Ansible to manage the deployment process. This integration is facilitated by the generation of YML files that contain detailed instructions for deploying the artifacts within the mainframe environment. These instructions ensure that the deployment is carried out correctly, with all necessary configurations applied, thus minimizing the risk of errors during this critical phase of the software lifecycle.

A particularly noteworthy aspect of the invention is its technology-agnostic design. Traditional mainframe systems are often tightly coupled with specific hardware and software, making it difficult to integrate them with more modern systems. BEARDS abstracts these platform-specific details, presenting them in a standardized format that can be understood by any modern CI/CD tool. This abstraction allows organizations to integrate their mainframe applications into existing CI/CD pipelines without requiring extensive customization or redevelopment efforts. This flexibility not only reduces the cost and complexity of such integrations but also allows organizations to leverage their existing DevOps investments to manage their mainframe environments more effectively.

Scalability is another important feature of the invention. BEARDS is designed to handle the demands of large-scale mainframe applications, which can involve complex builds and large volumes of data. The system's architecture supports the parallel processing of multiple build and deployment tasks, which helps to reduce bottlenecks and ensures that even the most demanding applications can be managed efficiently. This scalability is crucial for organizations that need to maintain and update extensive mainframe environments as part of their broader IT strategy.

Security is also a central consideration in the design of BEARDS. Mainframe applications often handle sensitive data and are subject to stringent regulatory requirements. BEARDS includes robust security features that ensure compliance with these requirements throughout the build and deployment process. The system provides detailed logging and audit trails that document each step of the process, allowing organizations to verify that all security protocols were followed and that the deployment was carried out in accordance with their policies. Additionally, the tools of the CI/CD pipeline support the implementation of approval processes and access controls, ensuring that only authorized personnel can initiate deployments to production environments.

Another key aspect of the invention is its support for agile development practices. While mainframe development has traditionally followed a waterfall model, which is linear and sequential, BEARDS enables organizations to adopt more iterative and flexible approaches. The system supports incremental builds, which only recompile the parts of the application that have changed. This capability allows for faster turnaround times and more frequent updates, aligning mainframe development with the principles of agile methodologies and improving the organization's ability to respond quickly to changing business needs.

The invention also supports the integration of mainframe applications with cloud-based services. As more organizations move toward hybrid cloud environments, the ability to integrate legacy systems like mainframes with cloud platforms becomes increasingly important. BEARDS provides the necessary connectors and interfaces to enable this integration, allowing organizations to leverage the scalability, flexibility, and cost-efficiency of cloud computing while maintaining their investment in mainframe systems. This capability is particularly valuable for organizations that are transitioning to cloud-based architectures and need to ensure that their mainframe applications can operate seamlessly within this new paradigm.

The invention's flexibility is further demonstrated by its configurability. BEARDS allows users to define custom build and deployment processes tailored to the specific needs of their organization. This includes the ability to manage multiple environments, integrate with various third-party tools, and customize the system's behavior to suit different types of applications. This configurability makes BEARDS a versatile solution that can be adapted to meet the unique requirements of any organization, regardless of the complexity of their IT environment or the specific tools they use in their CI/CD pipeline.

Collaboration is another area where BEARDS provides significant benefits. By offering a unified platform for managing the mainframe, BEARDS facilitates collaboration between development, operations, and security teams. This collaboration is critical for ensuring that mainframe applications are developed, tested, and deployed in a way that aligns with the organization's overall IT strategy. The system's detailed logging and reporting capabilities also provide valuable insights into the performance and status of the CI/CD pipeline, allowing teams to proactively identify and address issues before they impact production.

The invention is also designed with user-friendliness in mind. BEARDS provides an intuitive interface that allows developers and operations teams to manage the build and deployment process without requiring deep expertise in mainframe technologies. This ease of use is further enhanced by the system's integration with popular CI/CD tools, which allows users to continue working within their preferred environments. This reduces the learning curve associated with adopting BEARDS and increases its appeal to organizations that are looking to streamline their mainframe development processes without disrupting their existing workflows.

Finally, the invention offers a substantial return on investment for organizations that rely on mainframe systems. By automating and streamlining the build and deployment process, BEARDS reduces the time and cost associated with maintaining and updating mainframe applications. This efficiency not only improves the organization's ability to deliver new features and updates to market but also reduces the risk of errors and downtime, ensuring that critical mainframe applications remain reliable and secure. Overall, the invention represents a significant advancement in the field of mainframe development and DevOps, providing a comprehensive solution to the challenges associated with integrating legacy systems into modern software development practices.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

Terms such as “computers,” “machines,” and similar phrases are used interchangeably based on the context to denote devices that may be general-purpose or specialized for specific functions, whether virtual or physical, and capable of network connectivity. This encompasses all pertinent hardware, software, and components known to those skilled in the field. Such devices might feature specialized circuits like application-specific integrated circuits (ASICs), microprocessors, cores, or other processing units for executing, accessing, controlling, or implementing various types of software, instructions, data, modules, processes, or routines. The employment of these terms within this document is not intended to restrict or exclusively refer to any specific type of electronic devices or components, and should be interpreted broadly by those with relevant expertise. For conciseness and assuming familiarity, detailed descriptions of computer/software components and machines are omitted.

Software, executable code, data, modules, procedures, and similar entities may reside on tangible, physical computer-readable storage devices. This includes a range from local memory to network-attached storage, and various other accessible memory types, whether removable, remote, cloud-based, or accessible through other means. These elements can be stored in both volatile and non-volatile memory forms and may operate under different conditions such as autonomously, on-demand, as per a preset schedule, spontaneously, proactively, or in response to certain triggers. They may be consolidated or distributed across multiple computers or devices, integrating their memory and other components. These elements can also be located or dispersed across network-accessible storage systems, within distributed databases, big data infrastructures, blockchains, or distributed ledger technologies, whether collectively or in distributed configurations.

The term “networks” and similar references encompass a wide array of communication systems, including local area networks (LANs), wide area networks (WANs), the Internet, cloud-based networks, and both wired and wireless configurations. This category also covers specialized networks such as digital subscriber line (DSL) networks, frame relay networks, asynchronous transfer mode (ATM) networks, and virtual private networks (VPN), which may be interconnected in various configurations. Networks are equipped with specific interfaces to facilitate diverse types of communications—internal, external, and administrative—and have the ability to assign virtual IP addresses (VIPs) as needed. Network architecture involves a suite of hardware and software components, including but not limited to access points, network adapters, buses, both wired and wireless ethernet adapters, firewalls, hubs, modems, routers, and switches, which may be situated within the network, on its edge, or externally. Software and executable instructions operate on these components to facilitate network functions. Moreover, networks support HTTPS and numerous other communication protocols, enabling them to handle packet-based data transmission and communications effectively.

As used herein, Generative Artificial Intelligence (AI) or the like refers to AI techniques that learn from a representation of training data and use it to generate new content similar to or inspired by existing data. Generated content may include human-like outputs such as natural language text, source code, images/videos, and audio samples. Generative AI solutions typically leverage open-source or vendor sourced (proprietary) models, and can be provisioned in many ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used under various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models—Meta LLaMA (Language Model Meta AI): Designed to understand and generate human language, with a focus on diverse applications and efficiency. (3) Google AI Models:
(a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in biology and medicine. (5) NVIDIA AI Models—Megatron: A large, powerful transformer model designed for natural language processing tasks. (6) IBM AI Models—Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in generative AI. One or more of the foregoing may be used herein as desired. All are considered within the sphere and scope of this disclosure.

Generative AI and LLMs can be used in various parts of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and using large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

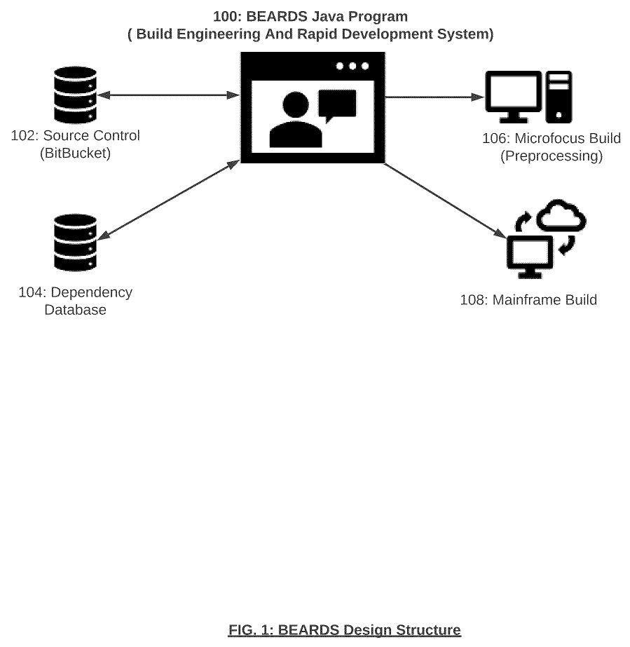

FIG. 1 provides a detailed visual representation of the architecture and operational flow of the Build Engineering And Rapid Development System, or BEARDS, which is central to the automation of the Continuous Integration/Continuous Deployment (CI/CD) pipeline for mainframe applications. The figure clearly depicts how BEARDS, identified by the numeral 100, acts as the orchestrator of various interconnected processes that are critical for the efficient development, testing, and deployment of mainframe applications. The design structure of BEARDS is intended to bridge the gap between legacy mainframe environments and modern CI/CD practices, allowing for a seamless integration that significantly enhances the efficiency and reliability of the software development lifecycle.

At the outset of the process, the source control system, represented by the numeral 102 and labeled as BitBucket, plays a foundational role in storing and managing the source code of the mainframe application. The detection of changes in the source code triggers Jenkins to execute BEARDS and retrieve the modified files from BitBucket. However, the retrieval process is not limited to merely copying the updated code; BEARDS also identifies all associated dependencies that the updated code relies on. This identification process is facilitated by the Dependency Database, indicated by the numeral 104 in FIG. 1.

The Dependency Database is a critical component of the BEARDS system, as it maintains an extensive and continuously updated map of the interdependencies between various components of the mainframe application. These dependencies could include other code files, libraries, or configuration settings that must be included in the build process to ensure the application functions correctly. By querying the Dependency Database, BEARDS can automatically determine which additional files or resources need to be retrieved alongside the modified source code. This automated approach to dependency management eliminates the need for manual tracking and ensures that all necessary components are present during the build process, reducing the risk of build failures due to missing or outdated dependencies.

With the source code and its dependencies retrieved, BEARDS proceeds to the next critical step: the generation of Job Control Language (JCL) jobs. These scripts are essential for the mainframe environment, as they provide the detailed instructions required to compile the source code into executable artifacts. The JCL jobs generated by BEARDS are not static; they are dynamically customized based on the specific requirements of the mainframe environment. This customization may involve setting specific compiler options, allocating memory resources, or scheduling jobs in a way that optimizes the build process for the particular characteristics of the mainframe system in use. The generation of these JCL jobs is a sophisticated process that reflects BEARDS's deep integration with the mainframe environment and its ability to adapt to the unique needs of each build.

Once the JCL jobs are prepared, BEARDS submits them to the mainframe environment, initiating the actual compilation process. The build process within the mainframe environment is illustrated in FIG. 1 by the Microfocus Build and Mainframe Build stages, denoted by the numerals 106 and 108, respectively. The Microfocus Build represents an intermediary step where specific files—particularly those not natively understood by the mainframe—are preprocessed or converted into a format that the mainframe can compile. This preprocessing is essential for ensuring that all components of the application, regardless of their original format, can be successfully integrated into the final build. Following the Microfocus Build, the Mainframe Build stage, indicated by numeral 108, is where the mainframe-specific source code is compiled into executable artifacts. This stage is the culmination of the build process, resulting in a set of compiled artifacts that are ready for further processing and eventual deployment.

After the build process is complete, BEARDS transfers the artifacts from the mainframe into a predetermined directory, accessible by Jenkins. Then, Jenkins manages the transfer of the compiled artifacts to a centralized storage system. This storage system, which could be a repository like JFrog Artifactory, is configured to store, version, and manage the artifacts for subsequent stages in the CI/CD pipeline. The transfer process is meticulously managed by Jenkins to ensure the integrity and security of the compiled artifacts. This involves generating and comparing hash values before and after the transfer to detect any potential corruption or inconsistencies, thereby ensuring that the artifacts remain intact and usable for deployment.

Moreover, BEARDS also generates YML files that contain detailed deployment instructions specific to the mainframe environment. These instructions are crucial for the deployment phase, as they specify the exact configurations, target datasets, and pre-deployment checks required to ensure that the compiled artifacts are deployed correctly. The YML files are utilized by CI/CD tools, such as Ansible, to execute the deployment process, ensuring that the artifacts are placed in the correct locations within the mainframe environment and are configured according to the specific needs of the application.

The post-deployment phase is equally critical, and the CI/CD tools (e.g. XLRelease, Ansible) are equipped to handle this phase with automated verification processes. These processes include checking that the deployment was successful, updating status logs, and notifying relevant stakeholders of the deployment outcome. This comprehensive approach ensures that the deployment process is not only accurate but also transparent, with detailed logs and audit trails provided by BEARDS and the other CI/CD tools, documenting each step of the build and deployment processes.

FIG. 1 encapsulates the complexity and sophistication of the BEARDS system, highlighting its ability to manage large-scale mainframe applications within a modern CI/CD pipeline. The integration of advanced dependency management, dynamic JCL job generation, meticulous artifact handling, and automated deployment processes makes BEARDS an essential tool for organizations seeking to modernize their mainframe environments while maintaining the reliability and security of their critical applications. The figure, through its depiction of BEARDS's interaction with the source control system, dependency database, build stages, and deployment tools, illustrates how this invention streamlines and enhances the mainframe software development lifecycle, ensuring that applications are always up-to-date, efficiently compiled, and securely deployed.

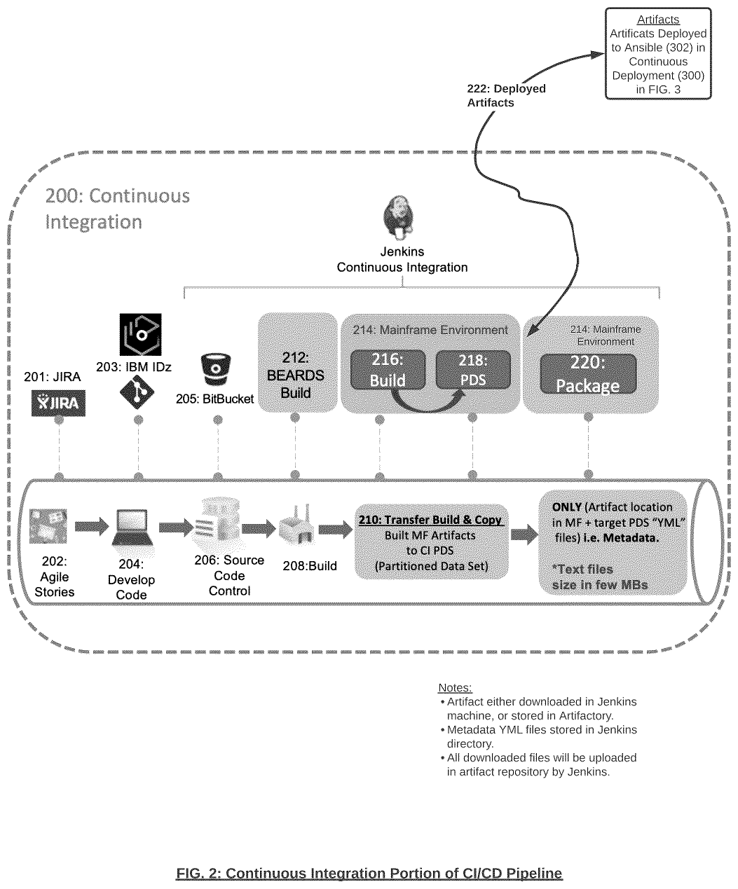

FIG. 2 offers a detailed and intricate depiction of the Continuous Integration (CI) portion of the CI/CD pipeline as managed by the BEARDS (Build Engineering And Rapid Development System) component, specifically designed for the efficient development, testing, and deployment of mainframe applications. The figure illustrates the interaction between BEARDS and various modern development tools, showing how BEARDS orchestrates and automates the CI process to ensure that mainframe applications are built, tested, and packaged seamlessly within the broader CI/CD pipeline.

The process begins with the Source Code Management system, depicted by numeral 206, which is identified as BitBucket in this figure. BitBucket is a popular distributed version control system that plays a crucial role in managing the source code of the mainframe application. Developers use BitBucket to commit changes to the source code, ensuring that every modification is tracked and versioned within a centralized repository. The continuous monitoring of this system by Jenkins is vital to the CI process, as it allows the detection of any changes made to the source code promptly. Once a change is detected, Jenkins executes BEARDS, which initiates the next phase of the CI process by retrieving the modified source code along with all associated dependencies, which are necessary for successful compilation.

The BEARDS Build, represented by numeral 212, is the next critical step in the process. This stage involves BEARDS compiling the mainframe application using the retrieved source code and dependencies. The build process is highly sophisticated, as it requires BEARDS to generate Job Control Language (JCL) jobs that provide the mainframe with the specific instructions needed to compile the source code into executable artifacts. These jobs are dynamically customized based on the requirements of the mainframe environment, ensuring that the build process is optimized for the specific characteristics of the system in use. The successful execution of the BEARDS Build step results in the creation of compiled artifacts, which are essential for the subsequent stages of the CI/CD pipeline.

Jenkins Continuous Integration, denoted by numeral 203, plays a pivotal role in orchestrating the CI process by automating the various tasks involved in building and integrating the mainframe application. Jenkins is a widely-used automation server that manages the execution of these tasks in a coordinated manner.

IBM IDz, represented by numeral 201, is another key component in FIG. 2. IBM IDz, or IBM Developer for Z Systems, is an integrated development environment (IDE) specifically tailored for mainframe application development. It provides developers with the tools needed to edit, debug, and test mainframe code effectively. The integration of IBM IDz within the CI pipeline underscores the importance of using specialized tools that cater to the unique needs of mainframe development. By leveraging the capabilities of IBM IDz, developers can work more efficiently, ensuring that the code they produce is of high quality and that any issues are identified and resolved early in the development process.

As the CI process continues, the compiled artifacts are subjected to a packaging stage, denoted by numeral 220 and labeled as Package. This stage is critical for organizing the compiled artifacts into a format suitable for deployment. The packaging process involves creating a structured collection of files that includes the compiled code, any necessary configuration files, and metadata that describes the contents and structure of the package. The purpose of this stage is to prepare the artifacts for transfer to the deployment phase of the CI/CD pipeline. Proper packaging ensures that the artifacts are easy to manage, deploy, and track as they move through the pipeline.

The Transfer Build & Copy stage, depicted by numeral 210, is where the packaged artifacts are transferred to the appropriate storage locations within the mainframe environment. This stage involves copying the artifacts to a Partitioned Data Set (PDS), a specialized storage format used in mainframe systems to manage multiple related datasets. The use of PDS is significant because it allows for the efficient organization and retrieval of the artifacts within the mainframe environment. By storing the artifacts in PDS format, the system ensures that they are readily accessible for further processing, testing, and eventual deployment.

BitBucket, indicated by numeral 205, continues to play a vital role throughout the CI process by managing the source code and maintaining a detailed history of changes. The integration of BitBucket within the CI pipeline ensures that all updates to the codebase are properly versioned and that the development process is transparent and traceable. This version control is essential for maintaining the integrity of the software development process, as it allows developers to revert to previous versions of the code if necessary and to collaborate effectively across distributed teams.

The CI process also involves the generation of YML files, which play a crucial role in the deployment phase. YML, or YAML (YAML Ain't Markup Language), is a human-readable data serialization format that is commonly used for configuration files and data exchange between systems. In the context of the CI pipeline, YML files generated by BEARDS contain detailed deployment instructions that specify how the compiled artifacts should be deployed within the mainframe environment. These instructions include information about target datasets, configuration parameters, and any pre-deployment checks that must be performed to ensure a successful deployment. The use of YML files is particularly advantageous because they are easy to read and modify, making them an ideal format for conveying complex deployment instructions in a clear and concise manner.

Once the YML files are generated, they are utilized by CI/CD tools such as Ansible to execute the deployment process. Ansible, a powerful automation tool, reads the instructions in the YML files and carries out the necessary steps to deploy the compiled artifacts to the specified locations within the mainframe environment. This process includes configuring the environment according to the parameters specified in the YML files, copying the artifacts to the correct locations, and performing any necessary checks to verify that the deployment was successful. The integration of Ansible within the CI pipeline ensures that the deployment process is automated, repeatable, and consistent, reducing the risk of human error and improving the overall efficiency of the pipeline.

The post-deployment phase, which follows the deployment process, involves a series of automated verification tasks managed by XLRelease and Ansible. These tasks include checking that the deployment was successful, updating status logs with the results of the deployment, and notifying relevant stakeholders of the deployment outcome. The verification process is essential for ensuring that the deployed artifacts are functioning correctly in the production environment and that any issues are promptly identified and addressed. The detailed logs and audit trails generated during this phase provide a comprehensive record of the deployment process, which is valuable for both operational purposes and compliance with security and regulatory requirements.

Overall, FIG. 2 illustrates the complexity and sophistication of the Continuous Integration process managed by BEARDS within the broader CI/CD pipeline. The figure highlights the seamless interaction between BEARDS, Jenkins, IBM IDz, BitBucket, and other tools, showcasing how these components work together to automate the build and packaging of mainframe applications. By integrating advanced dependency management, YML-based deployment instructions, and robust artifact handling, BEARDS ensures that the mainframe application is consistently updated and properly packaged for deployment, all within a fully automated and integrated CI pipeline. This comprehensive approach enables organizations to achieve faster, more reliable software releases while maintaining the high standards of quality and reliability required for mainframe environments.

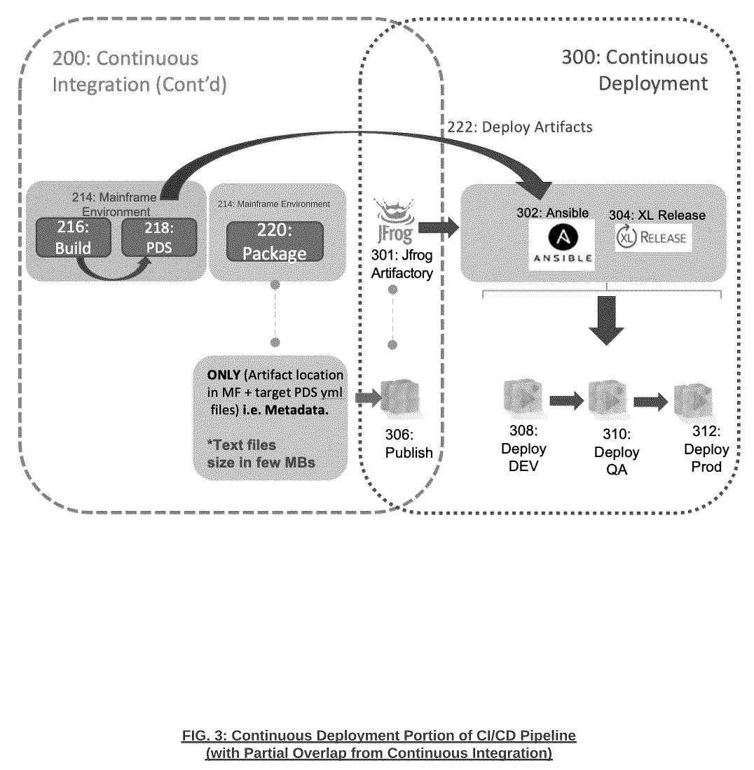

FIG. 3 provides an intricate view of the Continuous Deployment portion of the CI/CD pipeline, focusing on the deployment of mainframe applications orchestrated by the BEARDS (Build Engineering And Rapid Development System). The figure seamlessly transitions from the Continuous Integration (CI) phase, marked by numeral 200, into the Continuous Deployment (CD) phase, which is crucial for ensuring that the compiled mainframe artifacts are correctly deployed across various environments, thereby enabling a smooth and efficient release process. The Continuous Deployment phase is vital in the context of mainframe environments, where precision and reliability are paramount due to the mission-critical nature of the applications involved.

The deployment process begins with the ‘Package ONLY’ stage, represented by numeral 220, where the artifacts compiled during the CI phase are meticulously organized into deployable packages. These packages include not just the executable code but also the necessary metadata, which is crucial for the deployment process. The metadata, packaged into a separate file and also transferred into the artifact repository, provides detailed deployment instructions that guide the deployment process. These YML files are particularly important as they specify the exact configurations, datasets, and parameters needed to deploy the artifacts correctly within the mainframe environment. This meticulous packaging ensures that all elements required for deployment are included and that the deployment process can proceed without the risk of missing components or incorrect configurations.

Once the artifacts and the metadata YML files are packaged, they are transferred to JFrog Artifactory, depicted by numeral 301. JFrog Artifactory acts as a central repository, where these artifacts are securely stored and managed. This repository serves as the source of truth for the artifacts, ensuring that the exact versions intended for deployment are used and that they are available for all subsequent deployment stages. The secure storage of these artifacts is crucial, as it prevents unauthorized access or modifications, which could compromise the integrity of the deployment process.

Following their storage in JFrog Artifactory, the artifacts are then deployed to Ansible, as indicated by numeral 302. Ansible is a powerful automation tool that reads the instructions contained within the YML files and executes the deployment process accordingly. Ansible's role in the deployment phase is critical, as it ensures that the deployment is carried out with precision, automating tasks that would otherwise require manual intervention. This automation reduces the potential for human error, which is particularly important in the deployment of mainframe applications, where even minor mistakes can lead to significant disruptions or failures in the production environment.

Before Ansible is triggered, the process goes through XL Release, represented by numeral 304. XL Release is responsible for orchestrating the deployment across multiple environments, including development (DEV), quality assurance (QA), and production (Prod), denoted by numerals 308, 310, and 312, respectively. Each of these environments serves a distinct purpose in the deployment pipeline. The deployment begins in the DEV environment, where the artifacts are first deployed and tested in a controlled setting. This initial deployment allows developers to verify that the artifacts behave as expected before they are promoted to more critical environments.

Following the DEV deployment, the artifacts are moved to the QA environment. In the QA stage, the deployment undergoes rigorous testing to ensure that it meets all quality standards and that no defects or issues are present. This stage is crucial for identifying any potential problems before the artifacts are deployed to the production environment. The testing performed in the QA environment includes both functional and non-functional tests, covering aspects such as performance, security, and compliance. The goal is to catch and resolve any issues in the QA stage, thereby reducing the risk of defects reaching the production environment.

Once the artifacts have passed all QA tests, they are finally deployed to the production environment, indicated by numeral 312. The production environment is where the artifacts go live, meaning they are made available to end-users or are integrated into the operational systems of the organization. This final deployment is the culmination of the entire CI/CD pipeline, and it is carried out with the utmost care to ensure that the deployment is successful and that the application functions correctly in the live environment. The use of XL Release to coordinate this process ensures that the deployment is smooth and that any necessary steps, such as pre-deployment checks or post-deployment verifications, are automatically executed as part of the release process.

Security is a central concern throughout the deployment process, and XLRelease and Ansible are equipped with features that ensure the deployment is secure and compliant with industry standards. For example, they include access controls that restrict who can initiate deployments, ensuring that only authorized personnel can make changes to the production environment. Additionally, they log all actions taken during the deployment process, creating a detailed record that can be reviewed to ensure that all security protocols were followed. This focus on security is particularly important in the context of mainframe applications, which often handle sensitive data and are subject to strict regulatory requirements.

The scalability and flexibility of the deployment process depicted in FIG. 3 are also noteworthy. Ansible is designed to handle large-scale deployments across multiple environments, ensuring that even the most complex mainframe applications can be deployed efficiently and without errors. The system's ability to automate and streamline the deployment process reduces the time and resources required for each deployment, allowing organizations to deliver updates and new features to market more quickly. This scalability is essential for organizations that are looking to modernize their mainframe environments and integrate them into broader IT strategies that include cloud computing and other modern technologies.

In summary, FIG. 3 illustrates the sophisticated and highly automated process of Continuous Deployment as managed by XLRelease and Ansible. The figure highlights the seamless integration between various tools and systems, including JFrog Artifactory, Ansible, and XL Release, to ensure that mainframe applications are deployed accurately, securely, and efficiently across multiple environments. The detailed and comprehensive approach to deployment ensures that applications are always ready for production, reducing the risk of errors and downtime, and enabling organizations to maintain the high levels of reliability and performance required in mainframe environments.

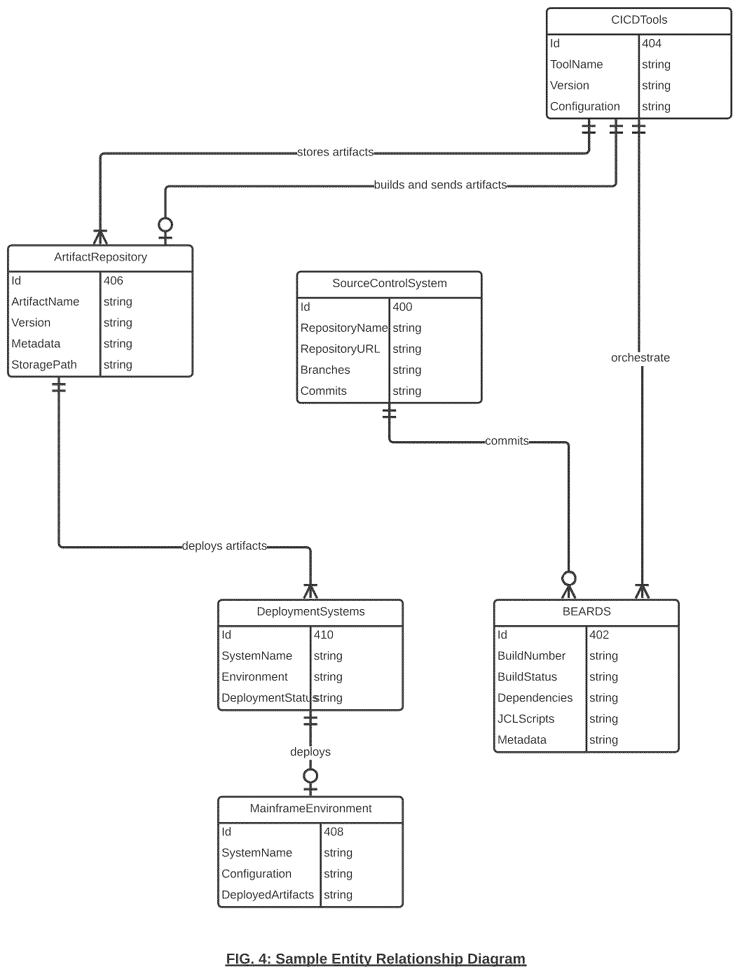

FIG. 4 is a detailed Entity-Relationship Diagram (ERD) that encapsulates the intricate interactions and dependencies between the various components that constitute the BEARDS (Build Engineering And Rapid Development System) within a CI/CD pipeline tailored for mainframe applications. The diagram serves as a visual representation of the system's architecture, illustrating how different entities collaborate to streamline the development, testing, and deployment of mainframe applications, which are known for their complexity and critical importance in enterprise environments.

At the center of this diagram is the SourceControlSystem entity, denoted by numeral 400, which plays a pivotal role in managing the version control of the application's source code. This entity is characterized by several key attributes: ‘RepositoryName’, ‘RepositoryURL’, ‘Branches’, and ‘Commits’. These attributes are essential as they define the structure of the source code repository, including the name of the repository, its location on a server, the various branches used for different stages of development, and the history of commits made by developers. The relationship between SourceControlSystem and other entities in the system is foundational, as the source control system is responsible for maintaining the integrity and version history of the source code, ensuring that all changes are tracked and can be traced back to specific commits. This entity directly interacts with BEARDS, triggering the build process whenever new code is committed.

The BEARDS entity, identified by numeral 402, is the heart of the CI/CD pipeline, orchestrating the entire process from build to deployment. BEARDS is equipped with attributes such as ‘BuildNumber’, which uniquely identifies each build process; ‘BuildStatus’, which indicates whether the build was successful, failed, or is still in progress; ‘Dependencies’, which list all the libraries, modules, and components required by the application; ‘JCLScripts’, which are the Job Control Language scripts generated to instruct the mainframe on how to compile and execute the code; and ‘Metadata’, which stores additional information related to the build process. The entity's relationships are numerous and complex, reflecting its central role in the pipeline. BEARDS receives source code from the SourceControlSystem and, using its dependency management capabilities, ensures that all required components are included in the build. It then generates JCL scripts tailored to the specific needs of the mainframe environment, ensuring that the build process aligns with the stringent requirements of mainframe operations.

The CICDTools entity, marked by numeral 404, represents the automation tools integrated into the pipeline to facilitate continuous integration and continuous deployment. This entity includes attributes like ‘ToolName’, ‘Version’, and ‘Configuration’, which describe the specific tools used (such as Jenkins, Ansible, and others), their versions, and their configuration settings. CICDTools are directly linked to BEARDS, assisting in the automation of the build and deployment processes. These tools orchestrate various tasks, such as triggering builds, running tests, and deploying artifacts to the target environments. The relationship between CICDTools and BEARDS is symbiotic, with BEARDS relying on these tools to automate repetitive tasks, thereby reducing the potential for human error and speeding up the deployment cycle.

The ArtifactRepository entity, represented by numeral 406, is crucial for the storage and management of the build artifacts generated by BEARDS. This entity's attributes include ‘ArtifactName’, which identifies each artifact; ‘Version’, which tracks the different versions of artifacts produced during the build process; ‘Metadata’, which stores descriptive information about each artifact; and ‘StoragePath’, which indicates where the artifact is stored within the repository. The ArtifactRepository serves as the central hub for all build artifacts, ensuring that they are securely stored and readily accessible for deployment.

The MainframeEnvironment entity, denoted by numeral 408, represents the operational environment where the mainframe application ultimately runs. This entity includes attributes such as ‘SystemName’, which specifies the name of the mainframe system; ‘Configuration’, which details the system's setup and parameters; and ‘DeployedArtifacts’, which lists the artifacts that have been deployed to this environment. The relationship between ArtifactRepository and MainframeEnvironment is direct, with artifacts being deployed from the repository to the mainframe environment. This deployment process is meticulously managed, ensuring that the artifacts are correctly configured and integrated into the mainframe's operational environment without disrupting existing services.

Finally, the DeploymentSystems entity, marked by numeral 410, encapsulates the tools and processes used to deploy artifacts from the ArtifactRepository to the MainframeEnvironment. Attributes for this entity include ‘SystemName’, identifying the deployment system (such as Ansible or XL Release); ‘Environment’, which specifies whether the deployment is to a development, quality assurance, or production environment; and ‘DeploymentStatus’, which tracks the progress and outcome of each deployment. The relationship between DeploymentSystems and the other entities, particularly ArtifactRepository and MainframeEnvironment, is critical as it ensures that the deployment is executed efficiently and correctly. DeploymentSystems are responsible for retrieving the appropriate artifacts from the repository and deploying them according to the instructions specified in the YML files generated by BEARDS. This process includes performing pre-deployment checks, applying the correct configurations, and verifying that the deployment was successful.

The diagram illustrates the flow of data and processes within the BEARDS system, highlighting how these entities interact to ensure that the mainframe application is developed, tested, and deployed in a controlled, efficient manner. BEARDS retrieves source code from SourceControlSystem, which then builds and provides artifacts to CICDTools, which sends them to ArtifactRepository. CICDTools orchestrate the process, ensuring that tasks are automated and streamlined, while DeploymentSystems handle the deployment of artifacts into the MainframeEnvironment. Each entity plays a distinct but interconnected role, forming a cohesive system that supports the complex requirements of mainframe application deployment within a modern CI/CD pipeline.

FIG. 4 serves as a comprehensive blueprint of the BEARDS system, detailing the intricate relationships and dependencies that drive the CI/CD process for mainframe applications. It emphasizes the importance of each entity and their interactions, showcasing how BEARDS integrates with various tools and systems to manage the entire lifecycle of mainframe application development and deployment. The diagram is an essential reference for understanding how this sophisticated system operates, ensuring that mainframe applications are consistently managed with the precision and reliability required in enterprise environments.

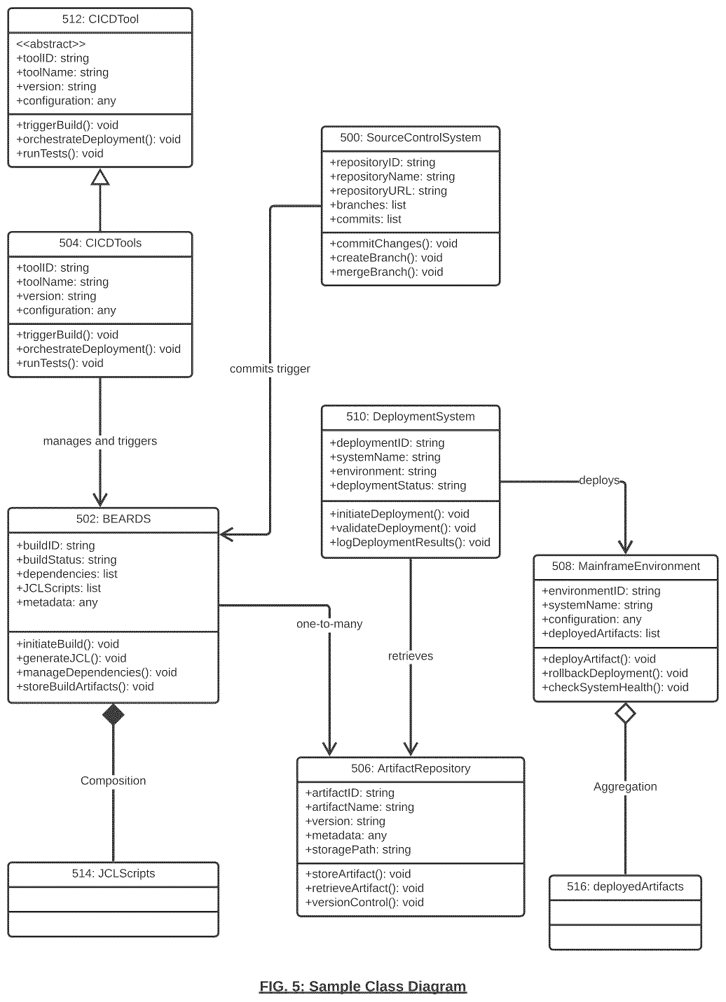

FIG. 5 is an exhaustive and detailed Class Diagram that serves as a blueprint for understanding the object-oriented architecture of the BEARDS (Build Engineering And Rapid Development System) within a CI/CD pipeline tailored specifically for the complex and highly specialized environment of mainframe applications. This diagram is essential for grasping the various classes, their attributes, methods, and the intricate relationships that exist between them, which together form the backbone of the system's functionality. Each class in this diagram represents a critical component of the system, and the interactions between these components ensure that the processes of building, testing, and deploying mainframe applications are handled with the precision and reliability required in enterprise environments.

At the foundation of this system is the SourceControlSystem class, denoted by the identifier 500. This class is fundamental to the overall architecture, as it is responsible for managing the version control of the application's source code, a crucial task within any CI/CD pipeline. The SourceControlSystem class includes several attributes that define its structure and functionality. The ‘repositoryID’ attribute serves as a unique identifier for each repository, ensuring that each repository can be distinctly referenced and managed within the system. The ‘repositoryName’ attribute stores the name of the repository, providing a human-readable label that developers can easily recognize. The ‘repositoryURL’ attribute holds the web address where the repository is hosted, allowing the system to locate and interact with the repository as needed. The ‘branches’ attribute is a list that tracks the various branches within the repository, each representing a different line of development, whether for feature development, bug fixes, or other purposes. The ‘commits’ attribute is a list that tracks the history of changes made to the source code, providing a detailed record of every modification, including who made the change and when it was made. These attributes are essential for the proper functioning of the SourceControlSystem class, ensuring that the source code is accurately tracked, versioned, and managed across different stages of development.

The SourceControlSystem class also includes several methods that facilitate the management of the source code. The ‘commitChanges( )’ method allows new code changes to be committed to the repository, updating the repository with the latest modifications. The ‘createBranch( )’ method enables the creation of new branches, allowing developers to work on different aspects of the application simultaneously without interfering with the main line of development. The ‘mergeBranch( )’ method handles the merging of branches back into the main line of development, integrating changes from various branches into a unified codebase. These methods are crucial for enabling collaborative development within the BEARDS system, allowing multiple developers to work on the same project without conflicts and ensuring that all changes are properly integrated and tracked.

At the center of the BEARDS system is the BEARDS class, identified by numeral 502. This class is the central orchestrator within the CI/CD pipeline, managing the entire process from the retrieval of source code to the final deployment of the application. The BEARDS class is defined by several key attributes that reflect its central role in the system. The ‘buildID’ attribute uniquely identifies each build process initiated by BEARDS, allowing the system to track and manage multiple builds simultaneously. The ‘buildStatus’ attribute indicates the current state of the build, providing real-time information on whether the build is successful, failed, or still in progress. The ‘dependencies’ attribute is a list of all the dependencies that must be resolved during the build process, ensuring that all necessary components are included and properly configured. The ‘JCLScripts’ attribute is a collection of Job Control Language jobs that BEARDS generates to instruct the mainframe on how to compile and execute the code. These jobs are tailored to the specific requirements of the mainframe environment, ensuring that the build process is optimized for the system's unique characteristics. The ‘metadata’ attribute stores additional information relevant to the build process, such as configuration settings, environment variables, and other data that may be needed to complete the build successfully.

The BEARDS class is equipped with several methods that reflect its role as the orchestrator of the CI/CD pipeline. The ‘initiateBuild( )’ method triggers the build process, initiating the compilation and packaging of the source code into executable artifacts. The ‘generateJCL( )’ method creates the necessary JCL jobs based on the requirements of the build, ensuring that the mainframe environment receives the correct instructions for compiling the code. The ‘manageDependencies( )’ method ensures that all dependencies are identified, retrieved, and included in the build process, reducing the risk of build failures due to missing components. The ‘storeBuildArtifacts( )’ method handles the storage of build artifacts in the artifact repository, ensuring that they are securely stored and versioned for future use. These methods are crucial for the smooth operation of the CI/CD pipeline, allowing BEARDS to manage the entire process from start to finish with minimal manual intervention.

The CICDTools class, marked by numeral 504, represents the various tools integrated into the CI/CD pipeline that work alongside BEARDS to automate and streamline the development process. This class includes attributes such as ‘toolID’, which serves as a unique identifier for each CI/CD tool, ensuring that each tool can be distinctly referenced and managed within the system. The ‘toolName’ attribute specifies the name of the tool, such as Jenkins or Ansible, which are widely used in CI/CD pipelines for automating various tasks. The ‘version’ attribute indicates the version of the tool in use, ensuring compatibility with other components of the system. The ‘configuration’ attribute stores the configuration settings required for the tool to operate effectively within the pipeline, allowing for customization and optimization of the tool's performance. The CICDTools class provides several methods that are essential for the automation of the CI/CD process. The ‘triggerBuild( )’ method initiates a build process using the specified tool, allowing for automated and repeatable builds. The ‘orchestrateDeployment( )’ method manages the deployment of artifacts across different environments, ensuring that the deployment is carried out correctly and efficiently. The ‘runTests( )’ method automates the execution of tests to validate the build, ensuring that any issues are identified and addressed before the application is deployed. These methods are critical for reducing manual intervention and enabling faster, more reliable deployments within the BEARDS system.

The ArtifactRepository class, represented by numeral 506, is responsible for the storage and management of artifacts generated by BEARDS during the build process. This class is defined by attributes such as ‘artifactID’, which uniquely identifies each artifact, ensuring that each artifact can be distinctly referenced and retrieved when needed. The ‘artifactName’ attribute provides a descriptive name for the artifact, making it easy for developers to identify and work with the correct artifact. The ‘version’ attribute tracks the version of each artifact, ensuring that the correct version is used at each stage of the deployment process. The ‘metadata’ attribute contains additional information about the artifact, such as its dependencies, build configuration, and other relevant data. The ‘storagePath’ attribute specifies the location within the repository where the artifact is stored, ensuring that it is easily accessible for deployment or further processing. The ArtifactRepository class includes several methods that are essential for the proper management of artifacts. The ‘storeArtifact( )’ method saves the artifact in the repository, ensuring that it is securely stored and versioned. The ‘retrieveArtifact( )’ method allows for the retrieval of stored artifacts when needed for deployment or further processing. The ‘versionControl( )’ method manages the different versions of artifacts, ensuring that the correct version is used at each stage of the CI/CD pipeline. These methods are crucial for ensuring that build artifacts are securely stored, versioned, and readily available for deployment within the BEARDS system.

The MainframeEnvironment class, indicated by numeral 508, represents the mainframe environment where the final application will be deployed. This class includes attributes such as ‘environmentID’, which uniquely identifies the mainframe environment, ensuring that each environment can be distinctly referenced and managed within the system. The ‘systemName’ attribute specifies the name of the mainframe system, providing a human-readable label that developers can easily recognize. The ‘configuration’ attribute details the system's setup and operational parameters, ensuring that the mainframe environment is correctly configured for the deployment of the application. The ‘deployedArtifacts’ attribute is a list of artifacts that have been successfully deployed within this environment, ensuring that the system tracks and manages the deployment of artifacts accurately. The MainframeEnvironment class provides several methods that are essential for the deployment process. The ‘deployArtifact( )’ method handles the deployment of artifacts to the mainframe, ensuring that the deployment is carried out correctly and efficiently. The ‘rollbackDeployment( )’ method enables the system to revert to a previous state if a deployment fails, ensuring that the mainframe environment remains stable and secure. The ‘checkSystemHealth( )’ method monitors the health and status of the mainframe environment, ensuring that it remains operational and ready for further deployments. These methods are crucial for ensuring that artifacts are correctly integrated into the mainframe environment and that the system remains stable and secure throughout the deployment process.

Finally, the DeploymentSystem class, labeled with numeral 510, encapsulates the tools and processes responsible for deploying artifacts from the ArtifactRepository to the MainframeEnvironment. This class includes attributes such as ‘deploymentID’, a unique identifier for each deployment process, ensuring that each deployment can be distinctly referenced and managed within the system. The ‘systemName’ attribute specifies the name of the deployment system in use, providing a human-readable label that developers can easily recognize. The ‘environment’ attribute indicates whether the deployment is occurring in a development, testing, or production environment, ensuring that the deployment is carried out in the correct context. The ‘deploymentStatus’ attribute tracks the progress and outcome of the deployment process, providing real-time information on whether the deployment is successful, failed, or still in progress. The DeploymentSystem class provides several methods that are essential for the deployment process. The ‘initiateDeployment( )’ method starts the deployment process, ensuring that the artifacts are deployed correctly and efficiently. The ‘validateDeployment( )’ method checks that the deployment was successful and meets all necessary criteria, ensuring that the application is correctly integrated into the mainframe environment. The ‘logDeploymentResults( )’ method records the results of the deployment for audit and review purposes, ensuring that the deployment process is transparent and accountable. These methods are crucial for ensuring that the deployment process is carried out smoothly, with all necessary checks and balances in place to prevent errors and ensure successful integration into the mainframe environment.

The diagram also includes abstract and concrete relationships between these classes, which are crucial for understanding how they interact within the BEARDS system. For example, the CICDTool abstract class, marked by numeral 512, represents a generalized version of CICDTools, from which specific tools like Jenkins or Ansible may inherit. This abstraction allows for flexibility in the system, enabling it to accommodate different CI/CD tools as needed. Similarly, JCLScripts and deployedArtifacts, denoted by numerals 514 and 516 respectively, represent critical elements that are managed by BEARDS and deployed within the MainframeEnvironment. These relationships illustrate the flow of processes and data between the classes, highlighting how BEARDS orchestrates the entire CI/CD pipeline from start to finish.

Overall, FIG. 5 is an intricate and detailed representation of the object-oriented structure of the BEARDS system, illustrating how different classes and their interactions form a cohesive system for managing the build, testing, and deployment of mainframe applications. This class diagram emphasizes the modularity, scalability, and flexibility of the BEARDS system, showing how each class plays a specific role in the CI/CD pipeline, from managing source code and dependencies to deploying artifacts and ensuring the stability of the mainframe environment. By providing a comprehensive view of the class structure within the BEARDS system, FIG. 5 offers valuable insights into how the system can be customized, extended, and integrated with various tools and environments to meet the specific needs of organizations managing complex mainframe applications. This diagram is essential for understanding the architecture and operation of the BEARDS system, offering a clear and detailed roadmap for implementing and managing CI/CD pipelines for mainframe applications.

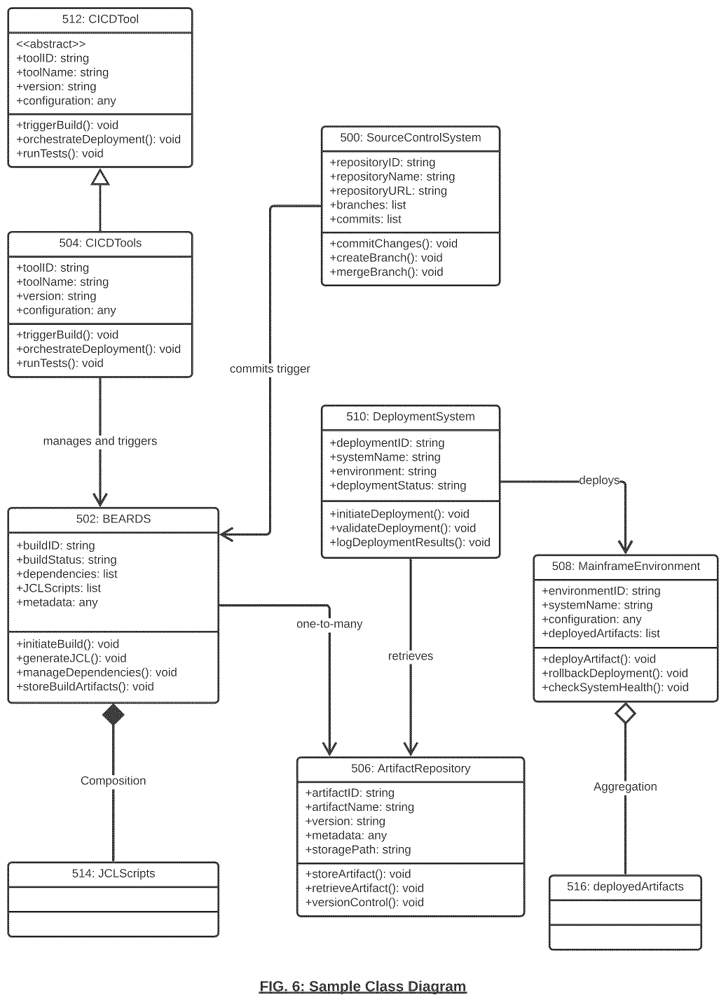

FIG. 6 is an extensively detailed sequence diagram that illustrates the complex and interrelated operations of the BEARDS (Build Engineering And Rapid Development System) within a Continuous Integration/Continuous Deployment (CI/CD) pipeline specifically designed for mainframe applications. The diagram provides a clear and thorough representation of the interactions between various system components, including developers, the source control system, the mainframe environment, the artifact repository, automation tools, stakeholders, and cloud services. Each step in the sequence is critical to ensuring that the CI/CD process is executed with the precision, security, and efficiency required in mainframe environments, which are known for their complexity and mission-critical nature.

The sequence begins when a developer initiates a code commit or makes changes to the source code within the source control system. This initial action, marked by numeral 600, triggers the entire CI/CD pipeline. BEARDS is then activated as depicted by numeral 602, and identifies all changes to the source code. BEARDS is capable of detecting updates to repository structures, branch modifications, individual commits, and merge operations. The system is specifically engineered to handle the complexities of multiple simultaneous updates and branch merges, ensuring that the integrity of the source code is maintained throughout the development process.

As soon as BEARDS detects any changes in the source code, it automatically retrieves the modified source code along with all associated metadata, version information, and dependencies from the source control system and the database. This retrieval process, represented by numeral 604, is comprehensive and ensures that every necessary piece of information is captured for the subsequent build process. BEARDS meticulously processes the retrieved data, ensuring that commit histories, branch-specific changes, and all dependencies are accurately integrated into the pipeline. This step is crucial for maintaining consistency and reliability as the system moves forward into the build phase.

Following the retrieval of the source code, BEARDS proceeds to generate Job Control Language (JCL) jobs, as indicated by numeral 606. These JCL jobs are customized to the specific needs of the mainframe environment, providing detailed instructions on how the mainframe should compile the source code. The generation of JCL jobs by BEARDS is a dynamic process, where the system adjusts compiler options, memory allocations, and execution parameters in real-time based on the current configuration and resource availability of the mainframe. This step is essential for optimizing the build process, ensuring that the system utilizes resources efficiently and that the generated artifacts meet the performance standards required by the mainframe environment.

Once the JCL jobs are generated, BEARDS initiates the build process within the mainframe environment, as shown by numeral 608. During this build process, the mainframe compiles the source code into executable artifacts. BEARDS plays a central role in overseeing the build process, managing each step to ensure that the compilation is carried out correctly. This process includes preprocessing tasks for files that are not natively supported by the mainframe, converting them into compatible formats and integrating them seamlessly into the build pipeline. The build process is a critical phase, as it transforms the raw source code into executable components that will ultimately be deployed in the mainframe environment.

After the artifacts have been compiled, BEARDS downloads the artifact into a predetermined directory accessible by Jenkins and validates them, as depicted by numeral 610. This validation is performed using a SHA-256 hash algorithm, a cryptographic function that generates unique hash values for the artifacts both before and after the transfer. These hash values are essential for verifying the integrity of the artifacts, ensuring that they have not been altered or corrupted during the downloading. This validation step is crucial for maintaining the security and reliability of the packaging process, as any discrepancy in the hash values could indicate potential issues that need to be addressed before proceeding further. BEARDS generates detailed YML deployment files, as shown by numeral 614. These YML files contain comprehensive instructions for deploying the artifacts within the mainframe environment. The instructions include configurations, dataset assignments, pre-deployment validation checks, and any other parameters necessary to ensure a successful deployment. The generation of these YML files is a critical preparatory step that ensures the deployment process is thoroughly planned and that all contingencies are accounted for, reducing the risk of errors or failures during deployment.

Once the artifacts have been downloaded and validated, they are securely transferred to an artifact repository for storage and version control, as indicated by numeral 612. The transfer process is carefully managed by Jenkins, which generates a new SHA-256 hash after the transfer to ensure that the artifacts remain intact and unaltered during the transfer. The artifact repository, which may be a system like JFrog Artifactory, is responsible for managing multiple versions of the artifacts, ensuring that each version is securely stored and readily accessible for future retrieval and deployment. This step is vital for preserving the history of the artifacts and allowing for rollback or reference to previous versions if necessary.

The deployment process is then executed by XLRelease and Ansible, as depicted by numeral 616. Using the generated YML files, Ansible carries out the deployment of the validated artifacts to the mainframe environment. The deployment process is highly orchestrated, with Ansible ensuring that each step is executed consistently and efficiently across the entire environment. This careful management of the deployment process is essential for maintaining the stability and security of the mainframe system, particularly in high-stakes environments where even minor disruptions can have significant consequences.

Ansible then generates and distributes detailed reports to stakeholders, as shown by numeral 620. These reports include any issues encountered during the deployment process. The reports are designed to keep stakeholders fully informed about the deployment process and its results, ensuring transparency and accountability at every stage. This step is particularly important for maintaining trust and confidence in the CI/CD pipeline, as it provides a clear record of what has been deployed and how it has been validated.

XLRelease and Ansible log all actions taken during the deployment in an immutable audit trail, providing a permanent record of the deployment process that can be reviewed for compliance and security purposes. This comprehensive approach to security ensures that the deployment process is fully protected against unauthorized access and tampering, and that the system remains compliant with relevant regulations and best practices.

Overall, FIG. 6 provides an expansive and detailed depiction of the sequence of operations within the BEARDS system, highlighting the complex interactions between various components as they work together to automate and optimize the CI/CD pipeline for mainframe applications. Each step in the sequence is meticulously detailed, ensuring that the deployment process is efficient, secure, and capable of handling the unique challenges of mainframe environments. The diagram emphasizes the importance of careful management and orchestration at every stage, from initial code commits through to post-deployment monitoring, making it a vital reference for understanding the full scope of the BEARDS system's capabilities.

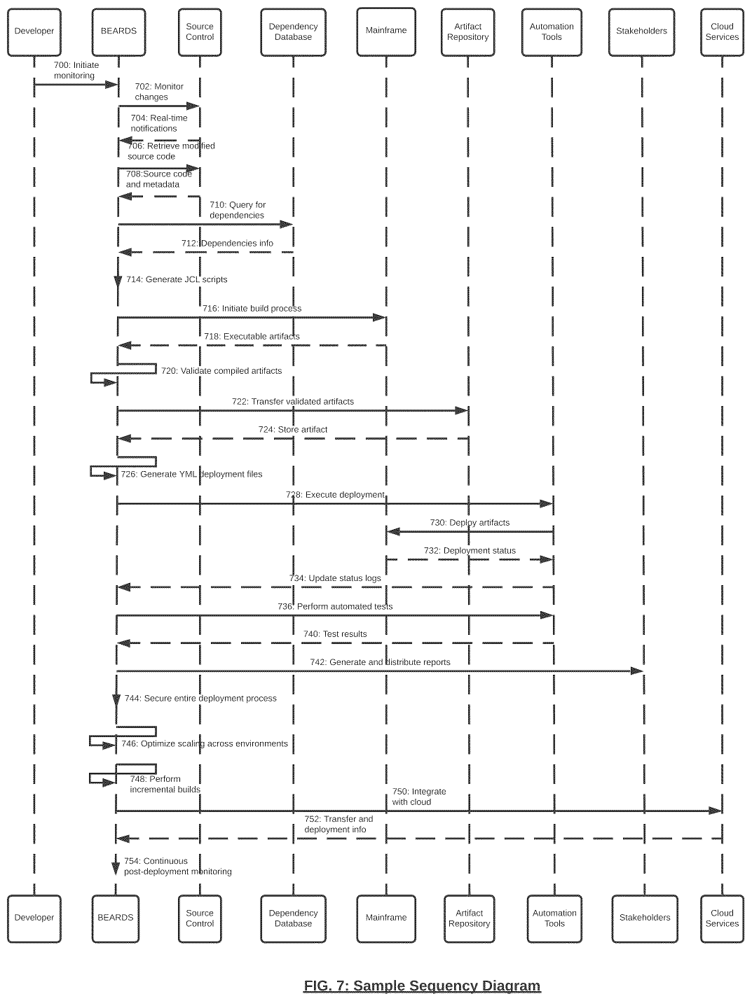

FIG. 7 is an intricate sequence diagram that meticulously details the interactions and processes involved in automating the Continuous Integration/Continuous Deployment (CI/CD) pipeline specifically designed for mainframe applications, managed by the BEARDS (Build Engineering And Rapid Development System). The figure provides a comprehensive view of the sequence of events, illustrating the step-by-step flow of operations across various system components, including developers, the source control system, the dependency database, the mainframe environment, the artifact repository, automation tools, stakeholders, and cloud services.

The process begins when a developer pushes some code in the source code management system. Jenkins is triggered, and it executes BEARDS.

BEARDS identifies any changes in the source code and retrieves the modified source code from the source control system, as shown by numeral 706. This retrieval process is comprehensive, encompassing not just the source code itself but also any associated metadata, version information, and dependencies that may have been affected by the recent changes. The retrieval, represented by numeral 708, ensures that all necessary information is available to support the subsequent build process, including detailed commit histories and branch-specific data that might impact the compilation and deployment of the code.

Once the source code is retrieved, BEARDS proceeds to query the dependency database, as denoted by numeral 710. This step is crucial for identifying any additional dependencies that the build process might require. The returned dependency information, marked by numeral 712, is then used to resolve any conflicts and ensure that all dependencies are correctly configured and ready for integration into the mainframe environment.

With the dependency information in hand, BEARDS generates Job Control Language (JCL) jobs tailored specifically to the requirements of the mainframe environment, as indicated by numeral 714. These jobs are generated dynamically, with BEARDS adjusting compiler options, memory allocations, and execution parameters based on a real-time analysis of the mainframe's current configuration, resource availability, and system load. The generation of these jobs is a critical step, as they provide the instructions necessary for the mainframe to compile and execute the source code effectively.

Following the job generation, BEARDS initiates the build process within the mainframe environment, represented by numeral 716. This initiation triggers the mainframe to begin compiling the source code into executable artifacts, as shown by numeral 718. The build process is meticulously managed, with BEARDS overseeing every aspect to ensure that the artifacts are generated correctly and efficiently. This includes preprocessing steps for files that are not natively supported by the mainframe, converting them into formats that are compatible and ensuring that the build process runs smoothly.

Once the artifacts are compiled, BEARDS transfers them from the mainframe into a predetermined directory accessible by Jenkins, and undertakes a rigorous validation process, as depicted by numeral 720. This validation involves the use of a SHA-256 hash algorithm to generate hash values both before and after the transfer process. These hash values are critical for verifying the integrity of the artifacts, ensuring that they have not been altered or corrupted during the transfer. Also, BEARDS generates YML deployment files, as represented by numeral 726. These YML files contain detailed deployment instructions that are specific to the mainframe environment, including configurations, dataset assignments, and pre-deployment validation checks. The generation of these files is a crucial step in preparing for deployment, ensuring that all necessary instructions and parameters are in place to facilitate a smooth and successful deployment process.

After the artifacts are validated, they are securely transferred by Jenkins to an artifact repository for storage and version control, as indicated by numeral 722. The transfer process is accompanied by the generation of a new SHA-256 hash, as shown by numeral 724, to verify that the artifacts remain intact during and after the transfer. The artifact repository, which may be a system like JFrog Artifactory, is responsible for managing multiple versions of the artifacts, ensuring that each version is stored securely and is readily accessible for future retrieval and deployment.

The deployment process is then executed by XLRelease and Ansible, as depicted by numeral 728, using the generated YML files. The system leverages automation tools, to carry out the deployment of the artifacts to the mainframe environment, as shown by numeral 730.

Ansible then generates and distributes detailed reports to stakeholders, as depicted by numeral 742. These reports provide a comprehensive overview of the deployment process. These reports are crucial for keeping stakeholders informed and ensuring that the deployment process is transparent and accountable.

Security is a key concern throughout the deployment process, and Ansible secures the entire process, as indicated by numeral 744. All actions taken during the deployment are logged in an immutable audit trail, ensuring that the process is fully compliant with security policies and regulatory requirements.

To further enhance the efficiency and scalability of the deployment, Ansible optimizes scaling across different environments, as depicted by numeral 746. This optimization includes the parallelization of tasks, efficient resource allocation, and the retention and caching of large artifacts within the mainframe environment to reduce the need for repeated external transfers. These measures ensure that the deployment process is scalable and capable of handling high-volume operations with minimal latency.

The system also supports incremental builds, as shown by numeral 748, where only modified or updated source code files are recompiled and redeployed. This approach significantly reduces the time and resources required for each build, while maintaining the integrity and consistency of the deployed application across all target environments. BEARDS ensures that incremental builds are seamlessly integrated with previous deployments, preserving the stability of the application.

Moreover, BEARDS integrates with cloud services, as indicated by numeral 750, enabling the transfer and deployment of artifacts between on-premise mainframe systems and cloud-based environments. This integration provides the flexibility and scalability needed to manage enterprise-level deployments in a hybrid cloud environment, while maintaining the security and integrity of the mainframe applications.

Overall, FIG. 7 provides an in-depth and comprehensive view of the sequence of operations within the BEARDS system. The diagram illustrates the complex interactions between various system components as they work together to automate and optimize the CI/CD pipeline for mainframe applications. Each step in the process is meticulously detailed, ensuring that the deployment process is efficient, secure, and capable of handling the unique challenges of mainframe environments.

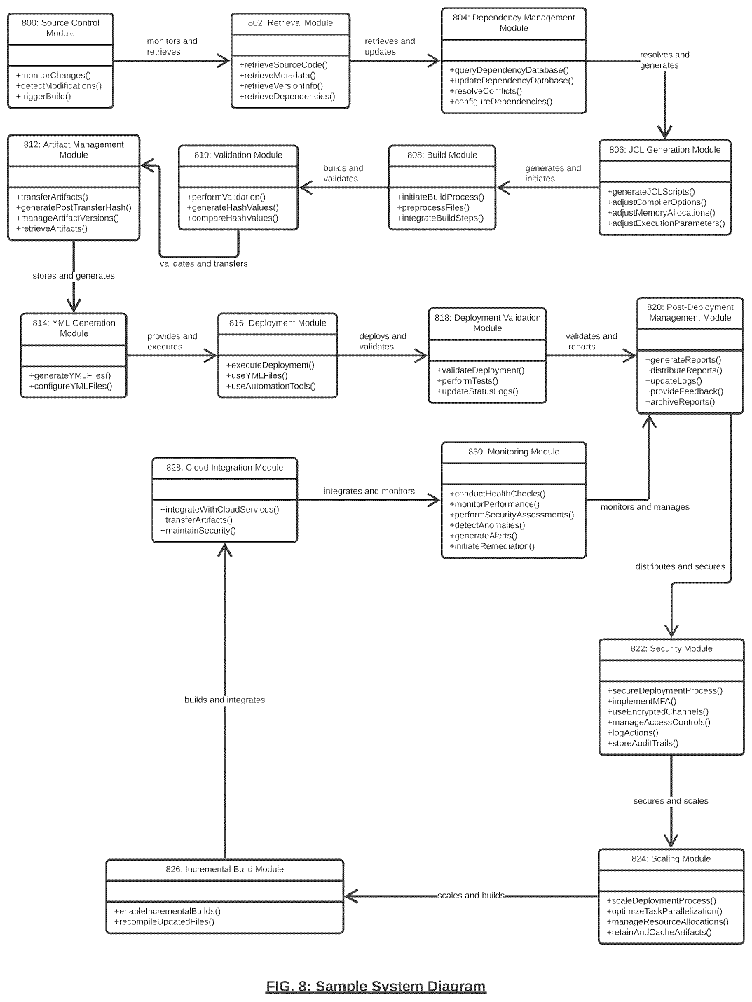

FIG. 8 presents an exceptionally detailed system diagram that encapsulates the intricate architecture and operations of the BEARDS (Build Engineering And Rapid Development System) as it functions within a CI/CD pipeline specifically designed for mainframe applications. This diagram serves as a foundational blueprint, illustrating how various modules within the BEARDS system are interconnected to automate, manage, and optimize the entire CI/CD process. It highlights the system's capability to handle everything from the initial monitoring of source code changes to the final post-deployment monitoring, ensuring that mainframe applications are deployed with the utmost efficiency, security, and reliability, which are paramount in mission-critical environments.

The sequence of operations begins with the Source Control Module, identified as numeral 800 in the diagram. This module plays a pivotal role in the early stages of the CI/CD pipeline by continuously monitoring the source control system for any changes in the source code. The module is designed to detect a wide range of modifications, including code commits, branch updates, merges, and even structural changes within the repository.

Directly interacting with the Source Control Module is the Retrieval Module, designated as numeral 802. This module is responsible for the crucial task of retrieving the modified source code from the source control system. However, the Retrieval Module's function extends beyond simply fetching code; it also captures all associated metadata, version information, and dependencies. This comprehensive retrieval ensures that every piece of information required for the build process is accurately gathered and preserved. The module's capability to handle complex retrievals, including data from various branches and commits, is vital for maintaining the integrity of the codebase as it moves through the pipeline. This thorough retrieval process lays a solid foundation for the subsequent steps in the CI/CD pipeline.

Once the source code and its dependencies have been retrieved, the Dependency Management Module, marked as numeral 804, comes into play. This module is designed to dynamically query the dependency database to identify any additional dependencies that the build process might require. It not only retrieves the necessary dependency information but also updates the database with any new dependencies discovered during the retrieval. Additionally, the Dependency Management Module is equipped with the capability to resolve conflicts between dependencies, ensuring that all required components are correctly configured and ready for integration into the mainframe environment. This module is instrumental in preventing build failures that could arise from missing or misconfigured dependencies, thereby ensuring a smooth and uninterrupted build process.

The next critical component is the JCL Generation Module, labeled as numeral 806, which is responsible for generating the Job Control Language (JCL) jobs necessary for the mainframe environment. JCL jobs are essential as they provide detailed instructions to the mainframe on how to compile and execute the source code. The JCL Generation Module dynamically adjusts various parameters, including compiler options, memory allocations, and execution settings, based on a real-time analysis of the mainframe's current configuration and resource availability. This dynamic adaptation ensures that the mainframe operates at optimal efficiency during the build process, maximizing resource utilization while maintaining the performance standards required for enterprise-level applications. The precision with which these scripts are generated is critical for the success of the subsequent build phase.

Following the generation of JCL jobs, the Build Module, identified by numeral 808, initiates the actual build process within the mainframe environment. This module oversees the compilation of the source code into executable artifacts, ensuring that every step of the build process is executed with accuracy and efficiency. The Build Module also incorporates preprocessing capabilities for files that are not natively supported by the mainframe, converting them into formats that are compatible with the mainframe's environment. This preprocessing is essential for integrating a wide range of source code files into the build process, ensuring that all components are correctly compiled and ready for deployment. The Build Module is central to transforming the source code into fully functional artifacts that are essential for the mainframe's operations.

Once the artifacts have been compiled and transferred into the Jenkins' directory, the Validation Module, marked as numeral 810, takes charge of ensuring their integrity. This module employs a SHA-256 hash algorithm to generate hash values for the artifacts both before and after the transfer process. These hash values are critical for verifying that the artifacts have not been altered or corrupted during the transfer process. This validation step is crucial for maintaining the security and reliability of the artifacts as they are prepared for deployment.

Following validation, the Artifact Management Module, identified by numeral 812, is responsible for transferring the validated artifacts to a version-controlled artifact repository, such as JFrog Artifactory. The transfer process is meticulously managed by the module, which generates a new SHA-256 hash post-transfer to verify that the artifacts remain intact during and after the transfer. The Artifact Management Module also oversees the management of multiple artifact versions, ensuring that each version is securely stored and easily accessible for future retrieval and deployment. This module plays a vital role in preserving the history and integrity of the artifacts, allowing for rollback or reference to previous versions if needed, which is especially important in complex and evolving mainframe environments.

Also, the YML Generation Module, labeled as numeral 814, generates the YML deployment files that contain the comprehensive instructions needed for deploying the artifacts within the mainframe environment. Those YML files are also uploaded into the artifact repository. These YML files are meticulously crafted to include all necessary configurations, dataset assignments, pre-deployment validation checks, and rollback procedures. The generation of these deployment files is a critical step in ensuring that the deployment process is well-organized and that all contingencies are accounted for. By providing detailed and precise instructions, the YML Generation Module ensures that the deployment process can be executed smoothly, minimizing the risk of errors or disruptions during deployment.

The deployment process itself is managed by the Deployment Module, denoted as numeral 816. This module is responsible for executing the deployment using the YML files generated earlier, along with leveraging automation tools such as Ansible. The Deployment Module ensures that the deployment is carried out consistently, efficiently, and securely across multiple environments, including development (DEV), quality assurance (QA), and production (PROD). This module orchestrates the deployment process, ensuring that each component is deployed correctly and that the entire system operates seamlessly post-deployment. The careful management of this process is crucial for maintaining the stability and functionality of the mainframe environment, particularly in high-stakes enterprise operations.

The Post-Deployment Management Module, labeled as numeral 820, handles all activities that occur after deployment. This module generates detailed reports that include any issues encountered during deployment. The reports are then distributed to stakeholders, ensuring that they are fully informed about the deployment process and its results. Additionally, the Post-Deployment Management Module updates the logs, provides real-time feedback on the deployment process, and archives the reports for future reference and compliance purposes. This module is crucial for maintaining transparency and accountability throughout the deployment process and for providing a comprehensive record of the deployment activities.

Security throughout the entire CI/CD pipeline is managed by the Security Module, indicated by numeral 822. This module implements a range of robust security measures designed to protect the integrity of the deployment process. Additionally, the Security Module logs all actions taken during the deployment in an immutable audit trail, providing a permanent record that can be reviewed for compliance and security purposes. The security features managed by this module are essential for ensuring that the deployment process is fully protected against unauthorized access and tampering, and that it complies with all relevant regulations and best practices.

The Scaling Module, labeled as numeral 824, optimizes the deployment process across multiple environments by managing task parallelization, resource allocation, and the retention and caching of large artifacts within the mainframe environment. This module is designed to ensure that the deployment process is scalable and capable of handling high-volume operations efficiently, reducing latency and enhancing overall performance. By optimizing these aspects of the deployment process, the Scaling Module ensures that the CI/CD pipeline can meet the demands of large-scale, enterprise-level deployments, where efficiency and reliability are paramount.

For environments that require frequent updates and iterations, the Incremental Build Module, identified by numeral 826, provides the capability to perform incremental builds. This module focuses on recompiling and redeploying only the modified or updated source code files, rather than rebuilding the entire application from scratch. By enabling incremental builds, this module significantly reduces the time and resources required for each build while maintaining the integrity and consistency of the deployed application across all target environments. The Incremental Build Module is particularly valuable in agile development environments where rapid iteration and continuous deployment are essential.

The Cloud Integration Module, marked as numeral 828, facilitates the seamless integration of the BEARDS system with cloud-based services. This module allows for the transfer and deployment of artifacts between on-premise mainframe systems and cloud-based environments, providing the flexibility and scalability needed to manage enterprise-level deployments in a hybrid cloud environment. The Cloud Integration Module ensures that the system can leverage cloud resources for testing, deployment, and scaling operations while maintaining the security and integrity of the mainframe applications. This module is crucial for organizations that operate in both on-premise and cloud environments, allowing them to take full advantage of the benefits of cloud computing without compromising on security or performance.

Finally, the Monitoring Module, denoted by numeral 830, conducts continuous post-deployment monitoring of the mainframe environment. This module performs automated health checks, performance monitoring, security assessments, and real-time anomaly detection. The Monitoring Module is equipped to generate immediate alerts in response to any detected issues, allowing for rapid intervention and remediation. Additionally, the module can initiate automated remediation processes to address any problems promptly, ensuring that the mainframe environment remains stable, secure, and fully operational over the long term. The continuous monitoring provided by this module is a critical component of the CI/CD pipeline, as it ensures that the deployed application continues to perform optimally and that any potential issues are detected and resolved as quickly as possible.

In summary, FIG. 8 provides an expansive and detailed depiction of the BEARDS system's architecture, illustrating how each module within the system interacts to manage and optimize the CI/CD pipeline for mainframe applications. The diagram highlights the modularity, scalability, and security of the system, ensuring that every aspect of the deployment process is handled with the highest level of precision and reliability. Each module is designed to perform specific tasks within the pipeline, contributing to a cohesive system that supports the complex requirements of mainframe environments. This system diagram is essential for understanding how BEARDS orchestrates the entire CI/CD process, from the initial monitoring of source code changes to continuous post-deployment management, making it an invaluable reference for the successful deployment of mainframe applications.

Pseudocode examples to implement one or more various aspects of the invention are set forth below for further non-limiting illustration purposes.

```
Source Control Monitoring
function monitorSourceControl( ):
  while true:
    changes = checkForChangesInSourceControl( )
    if changes are detected:
      triggerBuildProcess(changes)
    sleep(for a short interval)
Retrieval of Source Code and Metadata
function retrieveSourceCode(changes):
  sourceCode = fetchSourceCode(changes)
  metadata = fetchMetadata(changes)
  versionInfo = fetchVersionInfo(changes)
  dependencies = fetchDependencies(changes)
  return (sourceCode, metadata, versionInfo, dependencies)
JCL Script Generation
function generateJCLScripts(sourceCode, metadata, versionInfo):
  jclScript = initializeJCLScript( )
    jclScript.compilerOptions = adjustCompilerOptions(metadata,
versionInfo)
  jclScript.memoryAllocations = adjustMemoryAllocations(metadata)
        jclScript.executionParameters =
adjustExecutionParameters(metadata)
  jclScript.addSourceCode(sourceCode)
  return jclScript
Build Process Initiation
function initiateBuildProcess(jclScript):
  preprocessSourceCode(jclScript.sourceCode)
  executableArtifacts = compileSourceCode(jclScript)
  return executableArtifacts
Artifact Validation
function validateArtifacts(executableArtifacts):
  for artifact in executableArtifacts:
    originalHash = generateHash(artifact)
    downloadArtifact(artifact)
    newHash = generateHash(artifact)
    if originalHash != newHash:
      raise ValidationError(“Artifact integrity compromised”)
      return True
YML File Generation for Deployment
function generateYMLFiles(metadata, configuration,
datasetAssignments):
  ymlFile = initializeYMLFile( )
  ymlFile.configuration = configuration
  ymlFile.datasetAssignments = datasetAssignments
        ymlFile.preDeploymentChecks =
generatePreDeploymentChecks(metadata)
  ymlFile.rollbackProcedures = defineRollbackProcedures(metadata)
  return ymlFile
Dependency Management
function manageDependencies(dependencies):
  for dependency in dependencies:
    if dependency not in database:
      addDependencyToDatabase(dependency)
    else:
      resolveDependencyConflicts(dependency)
  updateDependencyDatabase(dependencies)
Artifact Management and Storage
function manageAndStoreArtifacts(executableArtifacts):
  for artifact in executableArtifacts:
    hash = generateHash(artifact)
    storeArtifactInRepository(artifact, hash)
  return artifactRepositoryLocation
Deployment Execution
function executeDeployment(ymlFile, automationTool):
  deploymentStatus = automationTool.deploy(ymlFile)
  if deploymentStatus.success:
    logDeploymentSuccess(ymlFile)
  else:
    handleDeploymentFailure(ymlFile)
  return deploymentStatus
Post-Deployment Validation and Reporting
function postDeploymentValidation(deploymentStatus):
  testResults = runAutomatedTests(deploymentStatus)
  if testResults.allPass:
    generateDeploymentReport(deploymentStatus, testResults)
  else:
    raise DeploymentValidationError(“One or more tests failed”)
  return testResults
Security Management
function secureDeploymentProcess( ):
  encryptAllCommunications( )
  implementRoleBasedAccessControl( )
  logAllActionsInAuditTrail( )
  if auditTrail.isTampered( ):
    raise SecurityBreachError(“Audit trail integrity compromised”)
  return True
Scaling Management
function manageScalingAcrossEnvironments(artifacts):
  for environment in environments:
    parallelizeTasks(environment)
    allocateResources(environment)
    cacheArtifacts(environment)
  return True
Incremental Build Management
function performIncrementalBuilds(changes):
  modifiedFiles = identifyModifiedFiles(changes)
  recompiledArtifacts = recompile(modifiedFiles)
  deployIncrementalBuild(recompiledArtifacts)
  return recompiledArtifacts
Cloud Integration and Monitoring
function integrateWithCloudServices(artifacts):
  cloudServices = connectToCloud( )
  transferArtifactsToCloud(cloudServices, artifacts)
  monitorCloudDeployment(cloudServices)
  if issuesDetectedInCloud( ):
    initiateCloudRemediation( )
  return True
```

The foregoing pseudocode for implementing the CI/CD pipeline system is a comprehensive representation of the core processes and functionalities required to automate, manage, and optimize the CI/CD pipeline specifically designed for mainframe applications. Each module and function plays a critical role in ensuring that the deployment process is handled with the utmost efficiency, security, and reliability, which are essential in the context of mission-critical mainframe environments.

The process begins with the ‘monitorSourceControl’ function, which is tasked with continuously observing the source control system for any modifications. This function operates within an infinite loop, periodically checking for changes such as code commits, branch updates, merges, or structural adjustments in the repository. When such changes are detected, the system triggers the build process by passing the relevant information to the ‘triggerBuildProcess’ function. To prevent excessive resource consumption, the monitoring loop includes a short sleep interval, ensuring that the system remains responsive without overwhelming the server with constant checks. This continuous and proactive monitoring is crucial for maintaining the pipeline's responsiveness and ensuring that the CI/CD process is always aligned with the latest developments in the codebase.

Once changes in the source control system are detected, the system moves to the ‘retrieveSourceCode’ function, which is responsible for gathering all necessary data from the source control system. This function retrieves not only the modified source code but also the associated metadata, version information, and dependencies that are crucial for the build process. The retrieval is comprehensive, ensuring that every piece of information, including detailed commit histories and branch-specific data, is accurately captured. The function then returns this collected data as a tuple, which will be used in subsequent steps to ensure that the build process has all the necessary context and resources to proceed without errors. The ability to retrieve and integrate such detailed information is vital for preserving the integrity and continuity of the codebase as it moves through the pipeline.

The system proceeds to the ‘generateJCLScripts’ function, which is responsible for creating the Job Control Language (JCL) jobs necessary for compiling and executing the source code on the mainframe. The function begins by initializing a new JCL job and then dynamically adjusts various parameters based on the metadata and version information retrieved earlier. These adjustments include setting compiler options to optimize performance, allocating the appropriate amount of memory to ensure efficient execution, and fine-tuning execution parameters to match the specific requirements of the mainframe environment. The source code is then added to the JCL job, which is returned for use in the build process. The ability to dynamically generate these scripts is critical for optimizing the build process, as it allows the system to adapt to the current state of the mainframe and ensure that resources are used effectively.

The ‘initiateBuildProcess’ function is the next step in the pipeline, where the actual compilation of the source code takes place. Using the JCL script generated in the previous step, the function initiates the build process on the mainframe. Before the compilation begins, the source code undergoes a preprocessing phase, particularly for files that are not natively supported by the mainframe. This preprocessing ensures that all source code is in a format compatible with the mainframe, reducing the risk of errors during compilation. The source code is then compiled into executable artifacts, which are returned for validation. This function is essential for transforming the raw source code into functional components that are ready for deployment, and it ensures that the build process runs smoothly and efficiently.

Once the build process is complete, the ‘validateArtifacts’ function is employed to ensure the integrity of the downloaded artifacts. This function uses a SHA-256 hash algorithm to generate hash values for each artifact both before and after the transfer process, from the mainframe into the Jenkins directory. The generated hash values are then compared to ensure that the artifacts have not been altered or corrupted during the transfer. If the hash values do not match, the system raises a validation error, indicating that the integrity of the artifacts has been compromised. This rigorous validation process is crucial for maintaining the security and reliability of the deployment, as it provides a strong guarantee that the artifacts are genuine and have not been tampered with during the downloading process.

The deployment phase is prepared with the ‘generateYMLFiles’ function, which creates detailed YML files containing all the necessary instructions for deploying the artifacts within the mainframe environment. This function initializes a YML file and populates it with configurations, dataset assignments, pre-deployment validation checks, and defined rollback procedures. The generated YML file provides a comprehensive set of instructions that guide the deployment process, ensuring that all steps are followed meticulously and that any potential issues are anticipated and addressed before they can cause disruptions. The careful preparation of these deployment files is critical for ensuring that the deployment process is smooth, efficient, and error-free.

Following that, the ‘manageDependencies’ function takes over. This function is designed to process the dependencies that were identified during the build phase. It iterates through each dependency, checking whether it exists in the dependency database. If a new dependency is found, it is promptly added to the database, ensuring that the build process is aware of all required components. In cases where a conflict arises, such as version mismatches or incompatible dependencies, the function resolves these conflicts to prevent build failures. The database is then updated with the latest dependency information, ensuring that it reflects the current state of the project. This dynamic management of dependencies is crucial for preventing build issues that could derail the deployment process and ensuring that all necessary libraries and tools are correctly configured.

Following validation, the ‘manageAndStoreArtifacts’ function is responsible for transferring the validated artifacts to a secure, version-controlled artifact repository. For each artifact, a new SHA-256 hash is generated post-transfer to ensure that the artifacts remain intact during and after the transfer. The function manages multiple versions of the artifacts, storing them securely and making them readily accessible for future retrieval and deployment. This step is vital for preserving the history of the artifacts and ensuring that they can be referenced or rolled back if necessary. The function returns the location of the stored artifacts in the repository, providing a clear and organized system for managing the outputs of the build process.

The actual deployment of the artifacts is handled by the ‘executeDeployment’ function, which uses the YML files generated earlier, along with automation tools such as Ansible, to carry out the deployment. The function checks the success of the deployment and logs the outcome. If the deployment is successful, the system records this success and proceeds to the next steps. However, if the deployment fails, the function activates the rollback procedures defined in the YML file to mitigate any issues and restore the system to its previous state. This function is essential for ensuring that the deployment process is executed consistently and securely across different environments, from development to production, and that any issues are promptly addressed.

The security of the deployment process is managed by the ‘secureDeploymentProcess’ function, which enforces a range of security measures. This function, encrypts all communications to protect data in transit, and applies role-based access controls to restrict actions to authorized personnel. Additionally, the function logs all actions taken during the deployment in an immutable audit trail, which is continuously monitored for any signs of tampering. If the audit trail shows evidence of tampering, the system raises a security breach error, indicating that the integrity of the deployment has been compromised. This function is essential for maintaining the security of the deployment process and ensuring that it complies with all relevant regulations and best practices.

The system's scalability across different environments is handled by the ‘manageScalingAcrossEnvironments’ function. This function ensures that the deployment process is optimized for various environments, including development, quality assurance, and production. The function parallelizes tasks to improve performance, allocates resources based on the specific needs of each environment, and caches large artifacts within the mainframe environment to reduce latency and improve deployment efficiency. By optimizing these aspects of the deployment process, the system can handle high-volume operations seamlessly, ensuring that even large-scale deployments are executed smoothly and without disruption.

For environments that require frequent updates and iterative development, the ‘performIncrementalBuilds’ function enables the system to recompile and redeploy only the modified or updated source code files, rather than rebuilding the entire application from scratch. This approach significantly reduces the time and resources required for each build while maintaining the integrity and consistency of the deployed application across all target environments. The function ensures that the system remains up-to-date with the latest code changes and that deployments are carried out efficiently, without the need for unnecessary recompilation of unchanged code.

The system's ability to integrate with cloud services is managed by the ‘integrateWithCloudServices’ function, which connects the BEARDS system to cloud-based resources. This function allows for the seamless transfer and deployment of artifacts between on-premise mainframe systems and cloud environments, providing the flexibility needed to leverage cloud resources for testing, deployment, and scaling operations. The function monitors the deployment in the cloud and initiates remediation processes if any issues are detected. This integration is essential for organizations that operate in hybrid cloud environments, allowing them to take full advantage of cloud computing without compromising on security or performance.

In summary, the pseudocode provided offers a detailed and comprehensive implementation of the CI/CD pipeline for mainframe applications. Each function is designed to handle specific tasks within the pipeline, from source code monitoring to post-deployment monitoring, ensuring that the entire process is managed with precision, efficiency, and security. The system's modular architecture allows for flexibility and scalability, making it well-suited for the complex and demanding environments in which mainframe applications operate. By following this pseudocode, developers can implement a robust and reliable CI/CD pipeline that meets the highest standards of enterprise-level deployment.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

The descriptions and figures provided in this disclosure serve to illustrate certain exemplary and non-limiting embodiments of the invention. However, the scope of the invention is not confined to these specific embodiments. Various other embodiments, variations, and modifications can be made that remain within the spirit and scope of the invention, and these alternative implementations might involve different structural arrangements, functional enhancements, or variations in the processes described. Such variations would be understood by persons of ordinary skill in the art as feasible based on the provided disclosure.

For instance, while the disclosed system utilizes a Java-based interface for the Build Engineering And Rapid Development System (BEARDS), alternative embodiments could implement BEARDS using other programming languages or frameworks, such as Python or Node.js, without deviating from the core functionality of automating mainframe application integration into CI/CD pipelines. These languages may offer different performance characteristics, integration capabilities, or development workflows that may be preferable in certain environments. An example could be an organization opting to implement BEARDS in Python due to its extensive libraries for data processing and easier integration with cloud-based services, allowing for more efficient handling of large datasets during the build process.

The invention describes a system where BEARDS manages dependencies through an internal database, but modifications could involve enhancing this system by integrating it with external dependency management tools or services. For example, a variant could interface with a cloud-based dependency management service, providing real-time updates and security patches for the libraries and modules used in the mainframe application. A version of BEARDS could integrate with an external service like JFrog Xray to automatically detect and mitigate security vulnerabilities in the dependencies, ensuring that only secure, up-to-date components are used in the build process.

Additionally, the invention uses Job Control Language (JCL) scripts for compiling and executing code within the mainframe environment. However, other embodiments might replace or augment JCL with modern scripting languages or automated job schedulers that offer more flexibility or easier integration with contemporary DevOps tools. For instance, instead of generating JCL scripts, an alternative embodiment might utilize Python scripts managed by Apache Airflow to orchestrate the build and deployment processes, providing a more user-friendly and flexible approach to job management.

The system generates YAML files for deployment configurations, but a different embodiment could use alternative configuration formats, such as JSON or XML, depending on the specific requirements of the deployment environment or the tools in use. This might be particularly relevant in environments where compatibility with certain tools is a priority. For example, in a deployment scenario that leverages Kubernetes, BEARDS might generate configuration files in JSON format, which could be more easily integrated with the Kubernetes API for automated scaling and management of containerized mainframe applications.

The invention could also be adapted to integrate with emerging technologies such as machine learning or artificial intelligence to optimize the build and deployment processes further. An enhanced embodiment might use AI to predict build failures based on historical data and automatically suggest fixes or optimizations. For instance, a machine learning model could be integrated into BEARDS to analyze previous builds' success rates and identify patterns that predict potential failures, allowing the system to preemptively adjust configurations or highlight areas that require developer attention before initiating a build.

The invention as described focuses on traditional mainframe environments, but the principles could be extended to hybrid or cloud-based mainframe environments. An alternative embodiment might include additional components to manage deployments across both on-premises and cloud infrastructures, providing seamless integration in a hybrid cloud environment. In a hybrid cloud setup, BEARDS could be configured to deploy certain components of a mainframe application to an on-premises environment while others are deployed to a cloud service like AWS or Azure, optimizing resource usage and ensuring that the most critical processes run in the environment best suited to their needs.

These examples illustrate just a few of the many possible variations, modifications, and alternative embodiments that fall within the scope of the invention. It is intended that all such variations and modifications be covered by the claims, ensuring that the invention remains flexible and adaptable to a wide range of potential applications and technological advancements.

1. A method for automating integration and deployment of mainframe applications into a Continuous Integration/Continuous Deployment (CI/CD) pipeline, the method comprising:
monitoring, by a CI/CD process, a source control system to continuously detect changes in the source code of a mainframe application, where the monitoring includes identifying modifications to repository structure, branch updates, and individual code commits;
retrieving, by a Build Engineering And Rapid Development System (BEARDS), modified source code, including any associated metadata and dependencies, from the source control system, wherein the retrieval process accounts for branch-specific changes and integrates any ongoing merge operations;
querying, by said BEARDS, a dependency database to automatically identify and resolve additional dependencies required for a build process, where the querying includes updating the dependency database with newly discovered or modified dependencies;
generating, by said BEARDS, Job Control Language (JCL) scripts tailored to specific requirements of a mainframe environment, wherein the generation process involves dynamically adjusting compiler options, memory allocation, and execution parameters based on current configuration and the specific needs of the build;
initiating, by said BEARDS, a build process within the mainframe environment using the generated JCL scripts to compile the source code into executable artifacts, including preprocessing steps for files not natively supported by the mainframe to ensure compatibility;
performing, by said BEARDS, a validation of downloaded artifacts from the mainframe using a SHA-256 hash algorithm to generate hash values before and after the transfer process, thereby ensuring the integrity of the artifacts and verifying that they have not been altered during the transfer process;
generating, by said BEARDS, YML files containing detailed deployment instructions specific to the mainframe environment, including configurations, dataset assignments, pre-deployment checks, and environment-specific parameters necessary to ensure a successful deployment;
transferring, by the CI/CD process, the validated compiled artifacts to an artifact repository for secure storage and version control, wherein the transfer process includes generating a new SHA-256 hash to ensure the integrity of the artifacts during and after the transfer;
deploying, by XLRelease and Ansible, the validated and versioned compiled artifacts from the artifact repository to the mainframe environment, utilizing the generated YML files to execute the deployment process while ensuring that all configurations and dataset assignments are correctly applied;
validating, by said Ansible, the deployment process through automated functional and non-functional tests, including SHA-256 hash-based validation to confirm that deployed artifacts match the versioned artifacts in the repository, and updating status logs to reflect success or failure of the deployment;
managing, by said XLRelease and said Ansible, the post-deployment process, including generating automated notifications to stakeholders, updating deployment status logs, and creating detailed reports that document each step of the deployment process and its outcomes;
securing, by XLRelease and Ansible, the deployment process by implementing role-based access controls to restrict who can initiate, monitor, or modify deployments, and logging all actions taken during the deployment in an immutable audit trail for compliance and security verification; and
scaling, by XLRelease and Ansible, the deployment process across multiple environments including development (DEV), quality assurance (QA), and production (PROD), where the scaling process involves handling parallel build and deployment tasks, ensuring consistency and integrity of artifacts across all environments, and managing large-scale deployments by retaining significant artifacts within the mainframe environment to minimize transfer overhead and enhance deployment efficiency.

2. The method of claim 1, wherein the monitoring step further comprises scanning the source control system at configurable intervals to detect changes in the repository, including real-time notifications of code commits, branch merges, and pull requests.

3. The method of claim 2, wherein the retrieving step further includes fetching related commit history, branch metadata, and version information from the source control system to ensure that all relevant data is available for the build process.

4. The method of claim 3, wherein the querying step further comprises dynamically updating the dependency database with any new dependencies detected during the build process, and automatically resolving conflicts between existing and newly discovered dependencies.

5. The method of claim 4, wherein the generating of the JCL jobs includes selecting optimal compiler settings and execution parameters based on real-time analysis of the mainframe's resource availability and workload.

6. The method of claim 5, wherein the initiating of the build process includes executing a preprocessing phase that converts non-native file formats into mainframe-compatible formats, ensuring that all source code is fully compatible with the mainframe's build environment.

7. The method of claim 6, wherein the performing of validation using the SHA-256 hash algorithm includes generating a hash value for each artifact both before and after the transfer process to ensure that no corruptions have occurred.

8. The method of claim 7, wherein the artifact repository is a version-controlled system, such as JFrog Artifactory, and the storing process includes managing multiple versions of the artifacts, with each version being associated with its respective SHA-256 hash for verification.

9. The method of claim 8, wherein the transferring of the validated compiled artifacts includes generating a new SHA-256 hash after the transfer to ensure the integrity of the artifacts during storage in the artifact repository.

10. The method of claim 9, wherein the generating of the YML files includes incorporating specific pre-deployment validation steps, such as environmental checks and dataset integrity verification, to ensure that the deployment is fully prepared before execution.

11. The method of claim 10, wherein the deploying step further includes using automation tools such as Ansible to execute the YML files, ensuring that the deployment is carried out consistently and efficiently across all target environments.

12. The method of claim 11, wherein the validating step includes conducting comprehensive tests in the quality assurance (QA) environment, encompassing both functional tests (e.g., unit tests, integration tests) and non-functional tests (e.g., performance testing, security testing) to ensure the deployed artifacts meet all required standards.

13. The method of claim 12, wherein managing of the post-deployment process includes automatically generating and distributing detailed deployment reports that include results of the SHA-256 hash validation, functional tests, and any issues encountered during deployment.

14. The method of claim 13, wherein the securing step includes implementing and encrypted communication channels for all deployment actions to enhance security of the deployment process.

15. The method of claim 14, wherein the securing step further includes creating an immutable audit trail that records every action taken during the deployment, with each entry being digitally signed and timestamped to prevent tampering.

16. The method of claim 15, wherein the scaling step includes optimizing the deployment process for high-volume environments by parallelizing tasks and using resource allocation strategies that reduce bottlenecks and ensure consistent deployment performance.

17. The method of claim 16, wherein the scaling step further includes managing large-scale deployments by retaining and caching significant artifacts within the mainframe environment, reducing need for repeated transfers from external storage systems and thereby enhancing deployment speed and reliability.

18. The method of claim 17, wherein said BEARDS enables incremental builds by only recompiling and deploying source code files that have changed, thereby reducing overall time and resources required for each build and ensuring faster turnaround times for application updates.

19. A method for automating integration, validation, and deployment of mainframe applications within a Continuous Integration/Continuous Deployment (CI/CD) pipeline using a system comprising BEARDS (Build Engineering And Rapid Development System), the method comprising:
continuously monitoring, by a CI/CD process, a source control system to detect changes in the source code of a mainframe application, including tracking modifications to repository structure, branch updates, individual code commits, and merge operations, where the monitoring involves and automated triggers for subsequent build processes;
retrieving, by BEARDS, modified source code, including associated metadata, version information, and dependencies, from the source control system, ensuring that all relevant branches, commit histories, and ongoing merges are incorporated into the retrieval process to maintain the integrity of a codebase;
dynamically querying, by BEARDS, a dependency database to identify and resolve additional dependencies required for the build process, where the querying includes automatically updating the dependency database with any new dependencies detected, after the completion of the build, resolving conflicts, and ensuring that all dependencies are correctly configured for a mainframe environment;
generating, by BEARDS, Job Control Language (JCL) jobs customized to specific requirements of the mainframe environment, where the generation process involves dynamically adjusting compiler options, memory allocations, and execution parameters based on a real-time analysis of the mainframe's resource availability, current system load, and configuration settings;
initiating, by BEARDS, a build process within the mainframe environment using the generated JCL jobs to compile the source code into executable artifacts, where the build process includes preprocessing steps for files not natively supported by the mainframe to ensure compatibility, as well as integrating additional build steps tailored to optimize performance, resource usage, and error handling;
performing, by BEARDS, a rigorous validation of downloaded artifacts using a SHA-256 hash algorithm, where hash values are generated both before and after the transfer process from the mainframe into a directory for the CI/CD process to ensure the integrity of the artifacts and verify that they have not been altered during the transfer;
generating, by BEARDS, detailed YML files containing comprehensive deployment instructions specific to the mainframe environment, where the YML files include configurations, dataset assignments, pre-deployment validation checks, environment-specific parameters, and rollback procedures that are necessary to ensure a successful and optimized deployment process;
securely transferring, by the CI/CD process, the validated compiled artifacts to an artifact repository that is version-controlled, such as JFrog Artifactory, where the transfer process includes generating a new SHA-256 hash post-transfer to ensure the integrity of the artifacts during storage, managing multiple versions of the artifacts, and associating each version with its respective hash value for easy retrieval, validation, and deployment;
executing, by XLRelease and Ansible, the deployment of the validated and versioned compiled artifacts from the artifact repository to the mainframe environment, utilizing the generated YML files to ensure that the deployment is carried out consistently, efficiently, and securely across multiple environments, including development (DEV), quality assurance (QA), and production (PROD);
managing, by XLRelease and Ansible, the post-deployment process, including automatically generating and distributing detailed deployment reports to stakeholders, which include the results of the SHA-256 hash validation, performance metrics, and any issues encountered during deployment, as well as updating deployment status logs, providing real-time feedback on deployment progress, and archiving the reports for future reference and compliance purposes;
securing, by XLRelease and Ansible, the entire deployment process through encrypted communication channels, role-based access controls, and immutable audit trails, where all deployment actions are logged, digitally signed, timestamped, and stored in a tamper-proof environment to ensure compliance with security policies and regulatory requirements;
scaling, by XLRlease and Ansible, the deployment process across multiple environments by optimizing task parallelization, managing resource allocation to reduce bottlenecks, and retaining and caching large artifacts within the mainframe environment to minimize the need for repeated external transfers, thereby enhancing deployment speed, reducing latency, and ensuring consistent performance, particularly in high-volume, enterprise-level operations;
enabling, by BEARDS, incremental builds where only modified or updated source code files are recompiled and redeployed, reducing the overall time, resource usage, and risk associated with each build, while maintaining the integrity and consistency of the deployed application across all target environments, and ensuring that subsequent builds integrate seamlessly with previous deployments; and
integrating, by BEARDS, with cloud-based services to support hybrid cloud environments, where artifacts and configurations are seamlessly transferred and deployed between on-premise mainframe systems and cloud-based infrastructure, providing flexibility, scalability, and the ability to leverage cloud resources for testing, deployment, and scaling operations, while maintaining the security and integrity of the mainframe applications.

20. A system for automating integration, validation, and deployment of mainframe applications within a Continuous Integration/Continuous Deployment (CI/CD) pipeline, the system comprising:
a source control module configured to continuously monitor a source control system for changes in the source code of a mainframe application, wherein the module is further configured to detect modifications to repository structure, branch updates, individual code commits, and merge operations, and to trigger subsequent build processes in response to detected changes;
a retrieval module configured to retrieve modified source code, including associated metadata, version information, and dependencies, from the source control system, wherein the module ensures that all relevant branches, commit histories, and merge operations are incorporated into the retrieval process;
a dependency management module configured to dynamically query a dependency database to identify and resolve additional dependencies required for the build process, wherein the module is further configured to automatically update the dependency database with any new dependencies detected during the build, resolve conflicts, and ensure that all dependencies are correctly configured for a mainframe environment;
a JCL generation module configured to generate Job Control Language (JCL) jobs customized to specific requirements of the mainframe environment, wherein the module dynamically adjusts compiler options, memory allocations, and execution parameters based on a real-time analysis of the mainframe's resource availability, system load, and configuration settings;
a build module configured to initiate a build process within the mainframe environment using the generated JCL jobs to compile the source code into executable artifacts, wherein the module further includes preprocessing capabilities for files not natively supported by the mainframe, and is configured to integrate additional build steps tailored to optimize performance, resource usage, and error handling;
a validation module configured to perform rigorous validation of the transferred artifacts, from the mainframe into a directory for a CI/CD process, using a SHA-256 hash algorithm, wherein the module generates hash values before and after the transfer process to ensure the integrity of the artifacts, and verify that they have not been altered during the transfer;
a YML generation module configured to generate detailed YML files containing comprehensive deployment instructions specific to the mainframe environment, wherein the YML files include configurations, dataset assignments, pre-deployment validation checks, environment-specific parameters, and rollback procedures to ensure a successful and optimized deployment process;
an artifact management module configured to securely transfer the validated compiled artifacts to an artifact repository that is version-controlled, such as JFrog Artifactory, wherein the module generates a new SHA-256 hash post-transfer to ensure the integrity of the artifacts during storage, manages multiple versions of the artifacts, and associates each version with its respective hash value for easy retrieval, validation, and deployment;
a deployment module configured to execute the deployment of the validated and versioned compiled artifacts from the artifact repository to the mainframe environment, wherein the module utilizes the generated YML files and automation tools such as Ansible to ensure that the deployment is carried out consistently, efficiently, and securely across multiple environments, including development (DEV), quality assurance (QA), and production (PROD);
a deployment validation module configured to validate the deployment process through automated functional and non-functional tests, including unit testing, integration testing, performance testing, and security testing, as well as SHA-256 hash-based validation to confirm that deployed artifacts match the versioned artifacts stored in the repository, and to update deployment status logs with detailed test results and deployment outcomes;
a post-deployment management module configured to manage the post-deployment process, including automatically generating and distributing detailed deployment reports to stakeholders, which include the results of the SHA-256 hash validation, test outcomes, performance metrics, and any issues encountered during deployment, as well as updating deployment status logs, providing real-time feedback on deployment progress, and archiving the reports for future reference and compliance purposes;
a security module configured to secure the deployment process through implementation encrypted communication channels, role-based access controls, and immutable audit trails, wherein all deployment actions are logged, digitally signed, timestamped, and stored in a tamper-proof environment to ensure compliance with security policies and regulatory requirements;
a scaling module configured to scale the deployment process across multiple environments by optimizing task parallelization, managing resource allocation to reduce bottlenecks, and retaining and caching large artifacts within the mainframe environment to minimize the need for repeated external transfers, thereby enhancing deployment speed, reducing latency, and ensuring consistent performance, particularly in high-volume, enterprise-level operations;
an incremental build module configured to enable incremental builds where only modified or updated source code files are recompiled and redeployed, reducing the overall time, resource usage, and risk associated with each build, while maintaining the integrity and consistency of the deployed application across all target environments, and ensuring that subsequent builds integrate seamlessly with previous deployments; and
a cloud integration module configured to integrate with cloud-based services to support hybrid cloud environments, wherein the module enables seamless transfer and deployment of artifacts and configurations between on-premise mainframe systems and cloud-based infrastructure, providing flexibility, scalability, and the ability to leverage cloud resources for testing, deployment, and scaling operations, while maintaining the security and integrity of the mainframe applications.
